(19) United States
(12) Patent Application Publication
(10) Pub. No.: US 2025/0294639 A1
(43) Pub. Date: Sep. 18, 2025

(54) METHOD, DEVICE AND COMPUTER PROGRAM PRODUCT FOR WIRELESS COMMUNICATION

(71) Applicant: ZTE CORPORATION, Shenzhen (CN)

(72) Inventors: Qiujin Guo, Shenzhen (CN); Mengzhu Chen, Shenzhen (CN); Bo Dai, Shenzhen (CN); Jun Xu, Shenzhen (CN); Xiaoying Ma, Shenzhen (CN); Xuan Ma, Shenzhen (CN); Hong Tang, Shenzhen (CN)

(73) Assignee: ZTE CORPORATION, Shenzhen (CN)

(21) Appl. No.: 19/222,434

(22) Filed: May 29, 2025

Related U.S. Application Data
(63) Continuation of application No. PCT/CN2023/075768, filed on Feb. 13, 2023.

(51) Int. Cl. H04W 76/28; H04W 52/02; H04W 72/232

(52) U.S. Cl. CPC H04W 76/28; H04W 52/0216; H04W 72/232

(57) ABSTRACT

A wireless communication method is disclosed. The method comprises: detecting, by a wireless communication terminal from a wireless communication node, cell discontinuous communication indication information for a cell discontinuous communication; and performing, by the wireless communication terminal, the cell discontinuous communication according to the cell discontinuous communication indication information.

### CROSS-REFERENCE TO RELATED PATENT APPLICATIONS

This application is a Continuation of US Application PCT/CN2023/075768, filed Feb. 13, 2023, incorporated herein by reference in its entirety.

### BACKGROUND

This document is directed generally to wireless communications.

The DRX (Discontinuous Reception) for UEs (user equipments) can be used to reduce the power consumption of UEs and network nodes. Further developments and applications of the DRX or similar discontinuous communication are widely discussed.

### SUMMARY

This document relates to methods, systems, and computer program products for a cell discontinuous communication.

One aspect of the present disclosure relates to a wireless communication method. In an embodiment, the wireless communication method includes: detecting, by a wireless communication terminal from a wireless communication node, cell discontinuous communication indication information for a cell discontinuous communication; and performing, by the wireless communication terminal, the cell discontinuous communication according to the cell discontinuous communication indication information.

Another aspect of the present disclosure relates to a wireless communication method. In an embodiment, the wireless communication method includes: transmitting, by a wireless communication node to a wireless communication terminal, cell discontinuous communication indication information for a cell discontinuous communication, to indicate the wireless communication terminal to perform the cell discontinuous communication according to the cell discontinuous communication indication information.

Another aspect of the present disclosure relates to a wireless communication terminal. In an embodiment, the wireless communication terminal includes a communication unit and a processor. The processor is configured to: detect, via the communication unit from a wireless communication node, cell discontinuous communication indication information for a cell discontinuous communication; and perform the cell discontinuous communication according to the cell discontinuous communication indication information.

Another aspect of the present disclosure relates to a wireless communication node. In an embodiment, the wireless communication node includes a communication unit and a processor. The processor is configured to: transmit, via the communication unit to a wireless communication terminal, cell discontinuous communication indication information for a cell discontinuous communication, to indicate the wireless communication terminal to perform the cell discontinuous communication according to the cell discontinuous communication indication information.

Various embodiments may preferably implement the following features:

Preferably or in some embodiments, the cell discontinuous communication comprises at least one of a discontinuous transmission, DTX, or a discontinuous reception, DRX.

Preferably or in some embodiments, for the cell discontinuous communication in a serving cell, during a cell discontinuous transmission active time, the wireless communication terminal performs at least one of:
monitoring a physical downlink control channel, PDCCH;
receiving a physical downlink shared channel, PDSCH;
transmitting a physical uplink control channel, PUCCH;
transmitting a physical downlink shared channel, PUSCH;
transmitting sounding reference signal, SRS, transmission;
performing channel state information, CSI, measurement;
reporting CSI report information;
monitoring a Random Access Response, RAR, or receiving an MsgB during a time window; or
starting, restarting, or keeping a first timer running,
wherein monitoring the PDCCH comprises at least one of monitoring a first PDCCH or monitoring a second PDCCH.

Preferably or in some embodiments, the first timer comprises at least one of a timer related to search space set group 1, SSSG1, or search space set group 2, SSSG2, for a PDCCH monitoring adaptation, or skipping a duration for a PDCCH monitoring adaptation, a bwp-InactivityTimer, a timer configured with a user equipment, UE, Connected Mode DRX, CDRX, a timer of a cell discontinuous communication on-duration, a timer of the cell discontinuous communication for data reception or transmission, a timer of a cell discontinuous communication active time, a timer of a cell discontinuous communication activation or enabling, a timer of a cell discontinuous communication deactivation or disabling, a timer of a cell discontinuous communication cycle, or a timer of the cell discontinuous communication.

Preferably or in some embodiments, the cell discontinuous transmission active time comprises one or more the following periods:
an Active Time of a user equipment, UE, DRX for the wireless communication terminal;
a period when a timer is running during a cell discontinuous communication cycle, in which the timer is configured for the cell discontinuous communication;
a period when a timer is running during a cell discontinuous communication cycle that is related to hybrid automatic repeat request acknowledgment, HARQ-ACK, information and/or a random access channel, RACH, procedure, in which the timer is configured for the cell discontinuous communication;
a period after that the wireless communication terminal reports HARQ-ACK information for a data transmission;
a period after that the wireless communication terminal reports a negative acknowledgment, NACK, for a data transmission;
a time duration between the wireless communication terminal reports a NACK for a data transmission and the wireless communication terminal receives data successfully;
a period when a timer related to a data retransmission executing during a cell discontinuous communication cycle is running;
a period when a drx-onDurationTimer or a drx-InactivityTimer is running;
a period when a drx-RetransmissionTimerDL, a drx-RetransmissionTimerUL or a drx-RetransmissionTimerSL is running;
a period after the wireless communication terminal is performing a Scheduling Request procedure;
a period when the wireless communication terminal is in a time window to monitor an RAR and/or receive an MsgB;
a cell discontinuous communication on-duration;
a period when a first timer is running; or
a period of a second cell discontinuous communication duration.

Preferably, a second cell discontinuous communication duration comprises at least one of:
a period for receiving a PDSCH for an initial transmission or a retransmission;
a period after an end of the cell discontinuous communication on-duration;
a period after the detection of the first or second PDCCH;
a period after a detection of a PDCCH scheduling a PDSCH or PUSCH;
a period after receiving a PDSCH or transmitting a PUSCH;
a period before a start of a next cell discontinuous communication cycle; or
a period before an end of a consecutive duration of a UE CDRX Active Time.

Preferably or in some embodiments, for the cell discontinuous communication in a serving cell, outside a cell discontinuous communication active time, the wireless communication terminal performs at least one of:
refraining from transmitting a Sounding Reference Signal, SRS;
refraining from reporting channel status information, CSI;
refraining from transmitting data on an uplink shared channel, UL-SCH;
refraining from transmitting on a RACH;
refraining from monitoring a first PDCCH;
refraining from monitoring a first PDCCH on a secondary cell, SCell, or for the SCell;
refraining from transmitting a physical uplink control channel, PUCCH;
refraining from receiving a downlink shared channel, DL-SCH;
cancelling an ongoing Random Access procedure;
stopping a first timer;
receiving a semi-persistent scheduling, SPS, physical downlink shared channel, PDSCH, reception; or
transmitting a configured grant, CG, physical uplink shared channel, PUSCH.

Preferably or in some embodiments, for a cell DTX in the cell discontinuous communication, the wireless communication terminal performs one or more first terminal behaviors comprising at least one of:
a measurement based on a reference signal, RS, common signals, or common channels;
a first PDCCH monitoring,
a semi-persistent scheduling, SPS, physical downlink shared channel, PDSCH, reception,
a PDSCH reception, or
a reception associated with a RACH procedure.

Preferably or in some embodiments, the reference signal comprises at least one of: a channel status information reference signal, CSI-RS, a semi-persistent CSI-RS, or an aperiodic CSI-RS, remote interference management reference signal, RIM-RS, positioning reference signal, PRS, a synchronization signal physical broadcast channel, SS/PBCH, block, a phase-tracking reference signal, PT-RS, a secondary synchronization signal, SSS, or a primary synchronization signal, PSS.

Preferably or in some embodiments, the first PDCCH monitoring comprises at least one of: a monitoring of a PDCCH carrying downlink, DL, scheduling information, or a monitoring of a PDCCH carrying at least one of Downlink Control Information, DCI, with a DCI format 1-0, DCI with a DCI format 1-1, DCI with a DCI format 1-2, DCI with a DCI format 2-0, DCI with a DCI format 2-1, DCI with a DCI format 2-2, DCI with a DCI format 2-3, DCI with a DCI format 2-4, DCI with a DCI format 2-5, DCI with a DCI format 2-6, or DCI with a DCI format 2-7; or
a cyclic redundancy check, CRC of the first PDCCH is scrambled by a Cell Radio Network Temporary Identifier, C-RNTI, a Cancellation Indication RNTI, CI-RNTI, a Configured Scheduling RNTI, CS-RNTI, an Interruption RNTI, INT-RNTI, a Slot Format Indication RNTI, SFI-RNTI, a Semi-Persistent CSI RNTI, SP-CSI-RNTI, a Transmit Power Control-PUCCH-RNTI, TPC-PUCCH-RNTI, a Transmit Power Control-PUSCH-RNTI, TPC-PUSCH-RNTI, a Transmit Power Control-Sounding Reference Symbols-RNTI, TPC-SRS-RNTI, an Availability Indication RNTI, AI-RNTI, a Sidelink RNTI, SL-RNTI, a Sidelink Configured Scheduling RNTI, SLCS-RNTI or a Sidelink Semi-Persistent Scheduling Vehicle-2-Everything RNTI, V-RNTI.

Preferably or in some embodiments, the wireless communication terminal performs the one or more first terminal behaviors for the cell DTX in response to at least one of the following conditions:
the wireless communication terminal is in a cell DTX active time;
the wireless communication terminal is in a cell DTX on-duration;
the wireless communication terminal is in a cell DTX cycle; or
the wireless communication terminal is in a period of a cell DTX on-duration or a cell DTX active time overlapped with a UE DRX on-duration or a UE DRX active time for the wireless communication terminal.

Preferably or in some embodiments, for a cell DRX in the cell discontinuous communication, the wireless communication terminal performs one or more second terminal behaviors comprising at least one of:
an SRS transmission,
a second PDCCH monitoring,
a scheduling request, SR, transmission,
a Configured Grant Physical Uplink Shared Channel, CG-PUSCH, transmission,
a PUCCH, or physical uplink shared channel, PUSCH, transmission, or
a transmission associated with a RACH procedure.

Preferably or in some embodiments, the second PDCCH monitoring comprises at least one of: a monitoring of a PDCCH carrying uplink, UL, scheduling information, or a monitoring of a PDCCH carrying at least one of DCI with a DCI format 0-0, DCI with a DCI format 0-1, DCI with a DCI format 0-2, DCI with a DCI format 2-0, DCI with a DCI format 2-1, DCI with a DCI format 2-2, DCI with a DCI format 2-3, DCI with a DCI format 2-4, DCI with a DCI format 2-5, DCI with a DCI format 2-6, or DCI with a DCI format 2-7; or
the CRC of the second PDCCH is scrambled by C-RNTI, CI-RNTI, CS-RNTI, INT-RNTI, SFI-RNTI, SP-CSI-RNTI, TPC-PUCCH-RNTI, TPC-PUSCH-RNTI, TPC-SRS-RNTI, AI-RNTI, SL-RNTI, SLCS-RNTI and/or SL Semi-Persistent Scheduling V-RNTI.

Preferably or in some embodiments, the wireless communication terminal performs one or more second terminal behaviors in the cell DRX in response to at least one of the following conditions:
the wireless communication terminal is in a cell DRX active time;
the wireless communication terminal is in a cell DRX on-duration;
the wireless communication terminal is in a cell DRX cycle; or
the wireless communication terminal is in a period of a cell DRX on-duration or a cell DRX active time overlapped with a UE DRX on-duration or a UE DRX active time for the wireless communication terminal.

Preferably or in some embodiments, for a cell DTX or a cell DRX, the wireless communication terminal performs one or more third terminal behaviors comprising at least one of a UE DRX operation for the wireless communication terminal, a timer behavior, one or more first terminal behaviors for the cell DTX, or one or more second terminal behaviors for the cell DRX.

Preferably or in some embodiments, the timer behavior comprises starting, restarting, running, or stopping a timer associated with the UE DRX operation, and the one or more first terminal behaviors for the cell DTX or the one or more second terminal behaviors for the cell DRX do not comprise starting, restarting, running, or stopping the timer associated with the UE DRX operation.

Preferably or in some embodiments, the cell discontinuous communication indication information comprises at least one of:
a cell DTX activation indicator;
a cell DTX deactivation indicator;
a cell DRX activation indicator;
a cell DRX deactivation indicator;
a switching indicator indicating a switch between different configuration sets of the cell discontinuous communication indication information or different candidate values of at least one of the one or more configuration parameters;
an indication to enable or disable a functionality of the cell discontinuous communication;
an indication to enable or disable one or more cell discontinuous communication cycles;
an indication to enable or disable one or more cell discontinuous communication on-durations;
a start of a cell discontinuous communication cycle;
a start of a cell discontinuous communication on-duration;
a length of a cell discontinuous communication cycle;
a length of a cell discontinuous communication on-duration;
an indication to enable or disable at least one of a signal transmission or a signal reception;
one or more offsets for the cell discontinuous communication;
a cell DTX activation or deactivation;
a cell DRX activation or deactivation;
a starting position of the cell discontinuous communication indication information in layer 1, L1, signaling; or
a cell DTX or cell DRX activation or deactivation for a group of cells.

Preferably or in some embodiments, the cell discontinuous communication indication information further comprises UE DRX indication information for the wireless communication terminal, and the UE DRX indication information comprises one or more UE DRX indication parameters comprising at least one of:
an indicator enabling or disabling a UE DRX functionality for the wireless communication terminal for a time duration;
a UE DRX activation or deactivation;
an indication to enable or disable one or more UE DRX cycles;
an indication to enable or disable one or more UE DRX on-durations;
a start offset of one or more UE DRX cycles;
one or more offsets used to determine at least one of a cell discontinuous communication cycle, a cell discontinuous communication, on-duration, a UE DRX cycle, or a UE DRX on-duration; or
a length of a UE DRX cycle.

Preferably or in some embodiments, the UE DRX indication information comprises one or more UE DRX indication sets comprising at least one of the one or more UE DRX indication parameters, a set identifier, a UE DRX cycle, a UE DRX on-duration timer, a UE DRX off-duration, or a UE DRX inactivity timer.

Preferably or in some embodiments, the at least one of a signal transmission or a signal reception comprises a transmission or a reception of at least one of an RS, uplink control information, UCI, a PUCCH, an SR, a PDCCH, a PDSCH, or a PUSCH.

Preferably or in some embodiments, the PUSCH includes type 1 configured grant PUSCH or type 2 configured grant PUSCH.

Preferably or in some embodiments, the indication to enable or disable at least one of a signal transmission or a signal reception is applied to at least one of a cell discontinuous communication on-duration, a cell discontinuous communication active time, a cell discontinuous communication cycle, a cell discontinuous communication off-duration, or a time outside a cell discontinuous communication active time.

Preferably or in some embodiments, the one or more offsets comprise at least one of:
an offset used to determine a start of a cell DTX cycle;
an offset used to determine a start of a cell DTX on-duration;
an offset used to determine a start of a cell DTX active time;
an offset used to determine a start of a cell DRX cycle;
an offset used to determine a start of a cell DRX on-duration;
an offset used to determine a start of a cell DRX active time;
an offset between a start of a cell DTX cycle and a cell DRX cycle;
an offset between a start of a cell DTX on-duration and a cell DRX on-duration; or
an offset between a start of a cell DTX active time and a cell DRX active time.

Preferably or in some embodiments, the cell discontinuous communication indication information further comprises at least one of an indication of a set of candidate values of the one or more configuration parameters; or an indication of one or more configuration sets comprising a set identifier and the one or more configuration parameters.

Preferably or in some embodiments, the one or more configuration sets satisfy at least one of the following:
one or more configuration parameters for a cell DTX in the one or more configuration sets are used for a cell DRX,
one or more configuration parameters for a cell DRX in the one or more configuration sets are used for a cell DTX, or
one or more configuration parameters for a cell DTX in the one or more configuration sets are used for both a cell DTX and a cell DRX.

Preferably or in some embodiments, the cell discontinuous communication indication information is indicated by DCI, and the cell discontinuous communication indication information satisfies at least one of:
a start bit of the cell discontinuous communication indication information is immediately after a secondary cell, SCell, dormancy indication field or a wake-up indication field;
a field of the cell discontinuous communication indication information in the DCI is a bitmap with a size equal to at least one of a number of corresponding UEs in a group, a number of groups of corresponding UEs, or a number of corresponding cell groups; or
the cell discontinuous communication indication information is indicated in a wake-up indication field of the DCI with the DCI format 2-6.

Preferably or in some embodiments, the cell discontinuous communication indication information is indicated in one or more PDCCH monitoring adaptation fields of at least one of DCI with a DCI format 0_1, DCI with a DCI format 0_2, DCI with a DCI format 1_1, DCI with a DCI format 1_2.

Preferably or in some embodiments, the cell discontinuous communication indication information is indicated in the one or more PDCCH monitoring adaptation fields in response to at least one of the following conditions being met:
the wireless communication terminal is operable to be provided with a set of durations by a list PDCCHSkippingDurationList for a PDCCH monitoring on an active DL bandwidth part, BWP, of a serving cell of the wireless communication terminal;
the wireless communication terminal is operable to be provided with one or more group indexes for a Type3-PDCCH Common Search Space, CSS, set or UE-specific search space, USS, set by a list searchSpaceGroupIdList-r17 for a PDCCH monitoring on an active DL bandwidth part, BWP, of a serving cell of the wireless communication terminal;
one of the one or more PDCCH monitoring adaptation fields has 2 bits;
a value of one of the one or more PDCCH monitoring adaptation fields is “11”; or
the cell discontinuous communication is supported by the wireless communication terminal or is configured for the wireless communication terminal by higher layer signaling.

Preferably or in some embodiments, the cell discontinuous communication indication information is indicated in a reserved-bits field of DCI with a DCI format 1_0 with a cyclic redundancy check, CRC scrambled by a Cell Radio Network Temporary Identifier, C-RNTI, a Configured Scheduling Radio Network Temporary Identifier, CS-RNTI, a Modulation and Coding Scheme Cell Radio Network Temporary Identifier, MCS-C-RNTI, a Paging Radio Network Temporary Identifier, P-RNTI, a System Information Radio Network Temporary Identifier, SI-RNTI, a Random Access Radio Network Temporary Identifier, RA-RNTI, an MsgB Radio Network Temporary Identifier, MsgB-RNTI, or a Temporary C-RNTI, TC-RNTI.

Preferably or in some embodiments, the cell discontinuous communication indication information is indicated in one or more fields of at least one DCI with a DCI format 0-0, DCI with a DCI format 0-1, DCI with a DCI format 0-2, DCI with a DCI format 1-0, DCI with a DCI format 1-1, DCI with a DCI format 1-2, DCI with a DCI format 3-0, DCI with a DCI format 2-0, DCI with a DCI format 2-1, DCI with a DCI format 2-2, DCI with a DCI format 2-3, DCI with a DCI format 2-4, DCI with a DCI format 2-5, DCI with a DCI format 2-6, DCI with a DCI format 2-7, or a DCI with DCI format new to NR Rel-17.

Preferably or in some embodiments, a bit field indicating the cell discontinuous communication indication information satisfies with at least one of:
one or more bits in the bit field are used to indicate the cell indication information;
one or more triggering states of the bit field are used to indicate cell indication information; or
a bitmap of the bit field is used to indicate the cell indication information;
wherein each triggering state corresponds to a state of the cell discontinuous communication indication information.

Preferably or in some embodiments, the cell discontinuous communication indication information is indicated by a Medium Access Control Control Element, MAC CE.

Preferably or in some embodiments, the wireless communication terminal applies the cell discontinuous communication indication information after an application delay from a reception of the cell discontinuous communication indication information.

Preferably or in some embodiments, the application delay is at least one of the following durations:
a duration between the reception of the cell discontinuous communication indication information and a beginning of a next cell discontinuous communication cycle or a next cell discontinuous communication on-duration;
a duration configured by higher layer parameter;
a duration with a length of one or more symbols, slots, subframes, frames, cell DTX cycles, or cell DRX cycles;
a duration determined by at least one of a Subcarrier Spacing, SCS, configuration for a serving cell of the wireless communication terminal, a cell discontinuous communication cycle, a start offset for the cell discontinuous communication, a start offset for a UE DRX for the wireless communication terminal, an offset, a cell discontinuous communication on-duration, a UE DRX cycle, a UE DRX on-duration, HARQ-ACK information, a value of a minimum applicable scheduling offset, or a number of data retransmission; or
a duration of 3 milliseconds after a report of HARQ-ACK information, wherein the HARQ-ACK information carries the HARQ-ACK information of an MAC CE that indicates the cell discontinuous communication indication information.

Preferably or in some embodiments, the wireless communication terminal refrains from monitoring a PDCCH during the application delay.

Preferably or in some embodiments, the wireless communication terminal applies the cell discontinuous communication indication information in at least one of the following manners:
the wireless communication terminal applies the cell discontinuous communication indication information for a current or next cell discontinuous communication cycle;
the wireless communication terminal applies the cell discontinuous communication indication information for one or more next subsequent cell discontinuous communication cycles; or
the wireless communication terminal applies and maintains the cell discontinuous communication indication information until a reception of updated cell discontinuous communication indication information.

Preferably or in some embodiments, the wireless communication terminal performs a detection for the cell discontinuous communication indication information during one or more time windows.

Preferably or in some embodiments, the wireless communication terminal detects at least one of first indication information during a first time window of the one or more time windows or second indication information during a second time window of the one or more time windows, wherein the first indication information comprises at least one of:
cell discontinuous communication indication information; or
the cell discontinuous communication indication information;
and wherein the second indication information comprises at least one of:
cell discontinuous communication indication information;
indication information associated with a UE DRX for the wireless communication terminal;
cell discontinuous communication indication information;
a wake-up or not-wake-up indication;
a SCell dormancy or non-dormancy behavior indication;
a minimum applicable scheduling offset indicator.

Preferably or in some embodiments, a time window of the one or more time windows is determined by at least one of:
a start offset used to determine a start of the time window;
an end offset used to determine an end of the time window;
a duration of the time window used to determine a length of the time window; or
a search space set configuration used to determine PDCCH monitoring occasions for the detection of cell discontinuous communication indication information.

Preferably or in some embodiments, in response to the wireless communication terminal detecting at least one of first indication information or second indication information, the wireless communication terminal performs one or more operations comprising at least one of:
performing a cell discontinuous communication operation according to first indication information;
performing a cell discontinuous communication operation according to second indication information;
performing a UE DRX operation according to second indication information;
ignoring first indication information;
ignoring second indication information;
ignoring indication information associated with the cell discontinuous communication indication information; or
ignoring indication information associated with a UE DRX for the wireless communication terminal.

Preferably or in some embodiments, the wireless communication terminal performs the one or more operations in response to at least one of the following conditions being met:
first DCI carrying the first indication information or second DCI carrying the second indication information is DCI with a DCI format 0-1, DCI with a DCI format 1-1, DCI with a DCI format 0-2, DCI with a DCI format 1-2, or DCI with a DCI format 2-6;
first DCI carrying the first indication information or second DCI carrying the second indication information indicates cell discontinuous communication indication information or indication information associated with a UE DRX for the wireless communication terminal;
an interval of time between detections of first DCI carrying the first indication information and second DCI carrying the second indication information is not larger than an application delay;
a first time duration that the first indication information applies overlaps with a second time duration that the second indication information applies;
a detection of first DCI carrying the first indication information or second DCI carrying the second indication information is during a period that a first time duration that the first indication information applies overlaps with a second time duration that the second indication information applies;
a time interval between a first PDCCH occasion for a detection of the first indication information and a second PDCCH occasion for detection the second indication information is smaller than or equal to an application delay; or
one or more first values of the first indication information are different from one or more second values of the second indication information.

Preferably or in some embodiments, in response to the wireless communication terminal detecting at least one of first indication information or second indication information, the wireless communication terminal refrains from expecting the first indication information being different from the second indication information, or assumes the first indication information and the second indication information being consistent.

The present disclosure relates to a computer program product comprising a computer-readable program medium code stored thereupon, the code, when executed by a processor, causing the processor to implement a wireless communication method recited in any one of foregoing methods.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows an example of a schematic diagram of a wireless terminal according to an embodiment of the present disclosure.

FIG. 2 shows an example of a schematic diagram of a wireless network node according to an embodiment of the present disclosure.

FIG. 3 shows an example of the cell DTX/DRX in accordance with an embodiment of the present disclosure.

FIG. 4 shows an example of the cell DTX/DRX in accordance with an embodiment of the present disclosure.

FIG. 5 shows an example of the cell DTX/DRX in accordance with an embodiment of the present disclosure.

FIG. 6 shows an example of the cell DTX/DRX in accordance with an embodiment of the present disclosure.

FIG. 7 shows an example of the cell DTX/DRX in accordance with an embodiment of the present disclosure.

FIG. 8 shows an example of the cell DTX/DRX in accordance with an embodiment of the present disclosure.

FIG. 9 shows an example of the cell DTX/DRX in accordance with an embodiment of the present disclosure.

FIG. 10 shows an example of the cell DTX/DRX in accordance with an embodiment of the present disclosure.

FIG. 11 shows an example of the cell DTX/DRX in accordance with an embodiment of the present disclosure.

FIG. 12 shows an example of the cell DTX/DRX in accordance with an embodiment of the present disclosure.

FIG. 13 shows an example of the cell DTX/DRX in accordance with an embodiment of the present disclosure.

FIG. 14 shows an example of the cell DTX/DRX in accordance with an embodiment of the present disclosure.

FIG. 15 shows an example of the cell DTX/DRX in accordance with an embodiment of the present disclosure.

FIG. 16 shows an example of the cell DTX/DRX in accordance with an embodiment of the present disclosure.

FIG. 17 shows an example of the cell DTX/DRX in accordance with an embodiment of the present disclosure.

FIG. 18 shows an example of the cell DTX/DRX in accordance with an embodiment of the present disclosure.

FIG. 19 shows a flowchart in accordance with an embodiment of the present disclosure.

FIG. 20 shows a flowchart in accordance with an embodiment of the present disclosure.

### DETAILED DESCRIPTION

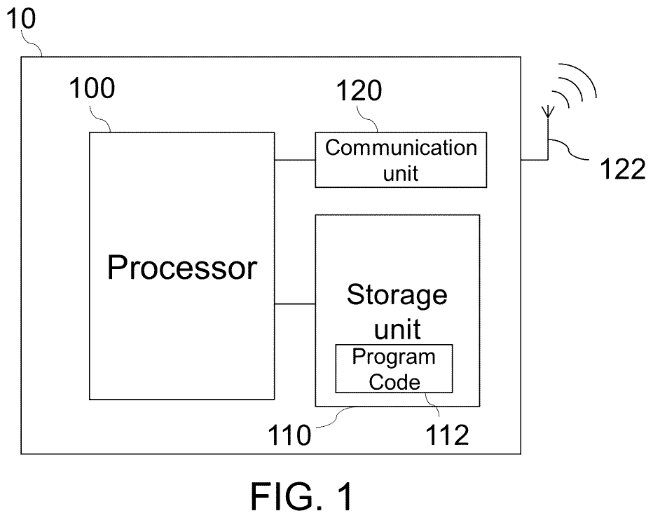

FIG. 1 relates to a schematic diagram of a wireless terminal 10 according to an embodiment of the present disclosure. The wireless terminal 10 may be a user equipment (UE), a mobile phone, a laptop, a tablet computer, an electronic book or a portable computer system and is not limited herein. The wireless terminal 10 may include a processor 100 such as a microprocessor or Application Specific Integrated Circuit (ASIC), a storage unit 110 and a communication unit 120. The storage unit 110 may be any data storage device that stores a program code 112, which is accessed and executed by the processor 100. Embodiments of the storage unit 110 include but are not limited to a subscriber identity module (SIM), read-only memory (ROM), flash memory, random-access memory (RAM), hard-disk, and optical data storage device. The communication unit 120 may a transceiver and is used to transmit and receive signals (e.g., messages or packets) according to processing results of the processor 100. In an embodiment, the communication unit 120 transmits and receives the signals via at least one antenna 122 shown in FIG. 1.

In an embodiment, the storage unit 110 and the program code 112 may be omitted and the processor 100 may include a storage unit with stored program code.

The processor 100 may implement any one of the steps in exemplified embodiments on the wireless terminal 10, e.g., by executing the program code 112.

The communication unit 120 may be a transceiver. The communication unit 120 may as an alternative or in addition be combining a transmitting unit and a receiving unit configured to transmit and to receive, respectively, signals to and from a wireless network node (e.g., a base station).

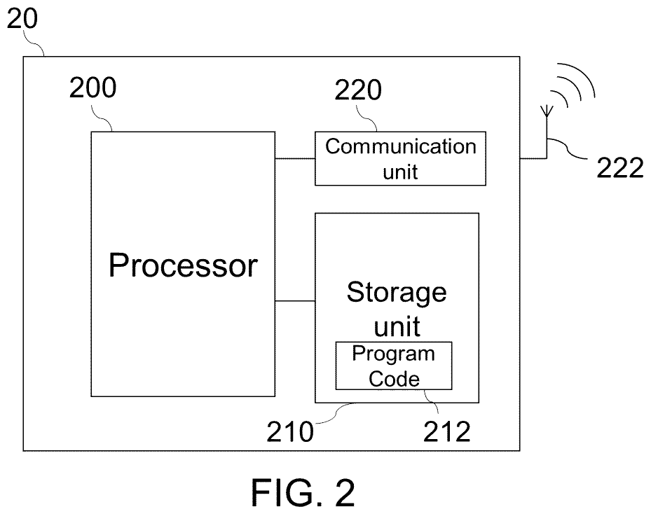

FIG. 2 relates to a schematic diagram of a wireless network node 20 according to an embodiment of the present disclosure. The wireless network node 20 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 20 may comprise (perform) at least one network function such as an access and mobility management function (AMF), a session management function (SMF), a user place function (UPF), a policy control function (PCF), an application function (AF), etc. The wireless network node 20 may include a processor 200 such as a microprocessor or ASIC, a storage unit 210 and a communication unit 220. The storage unit 210 may be any data storage device that stores a program code 212, which is accessed and executed by the processor 200. Examples of the storage unit 210 include but are not limited to a SIM, ROM, flash memory, RAM, hard-disk, and optical data storage device. The communication unit 220 may be a transceiver and is used to transmit and receive signals (e.g., messages or packets) according to processing results of the processor 200. In an example, the communication unit 220 transmits and receives the signals via at least one antenna 222 shown in FIG. 2.

In an embodiment, the storage unit 210 and the program code 212 may be omitted. The processor 200 may include a storage unit with stored program code.

The processor 200 may implement any steps described in exemplified embodiments on the wireless network node 20, e.g., via executing the program code 212.

The communication unit 220 may be a transceiver. The communication unit 220 may as an alternative or in addition be combining a transmitting unit and a receiving unit configured to transmit and to receive, respectively, signals to and from a wireless terminal (e.g., a user equipment or another wireless network node).

In the paragraphs below, details will be described along with some examples, but the present disclosure is not limited to the examples below.

In some approaches, the gNB (gNodeB) can use network DTX (data transmission)/DRX with restrictions based on the UE DRX configurations and configured transmissions/receptions, e.g., common channels/signals. C-DRX (Connected Mode Discontinuous Reception) may be configured per UE. The alignment of the DRX cycles or offsets for different UEs may be done only via RRC (Radio Resource Control) signaling. During the DRX off-duration, the UE does not expect to monitor the PDCCH (physical downlink control channel), but it is allowed to initiate the UL (uplink) transmission according to the configured resources (e.g., using the PUCCH or RACH (random access channel), or CG-PUSCH (configured grant Physical Uplink Shared Channel)).

Some embodiments of the present disclosure relate to adaptation of a cell DTX/DRX aiming at providing the necessary signaling mechanisms enabling the cell to stay inactive. The cell DTX/DRX may be configured by UE-specific RRC signaling. In some embodiments of the present disclosure, one or more of the following issues may be solved.

Issue1: How to ensure a longer gNB sleep period when the DTX/DRX operation is configured?

Issue2: How to trigger the cell DTX/DRX activation/deactivation?

Issue3: How to reduce the network congestion possibility when data transmissions for all of the UEs camping on the cell are scheduled on the same DRX on-duration?

Issue4: For a UE or UEs not supporting the cell DTX/DRX, how to access the cell with the cell DTX/DRX?

In some embodiments, the adaptation of the cell DTX/DRX may provide signaling mechanisms enabling the cell to stay inactive. This includes enhancements to the UE DRX configuration, e.g., to align or omit DRX cycles or start offsets of DRX, for UEs in connected mode or idle/inactive mode, potentially allowing longer opportunities for cell inactivity. During a cell DTX/DRX, the cell may have no transmission/reception or only keep limited transmission/reception. For example, the cell does not need to transmit or receive some periodic signals/channels, such as common channels/signals or UE specific signals/channels.

In some embodiments, the cell DTX/DRX on duration is the time duration when the cell DTX/DRX on duration timer is running.

In some embodiments, the cell DTX/DRX may indicate at least one of the cell DTX, and/or the cell DRX and/or alignment of cell DTX/DRX and UE DRX.

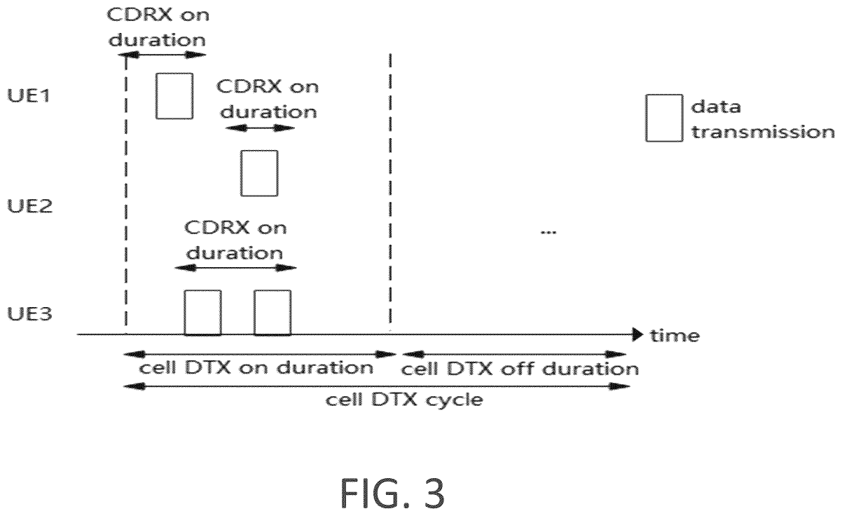

In some embodiments, the alignment of cell DTX/DRX and UE DRX means that the UE DRX on-duration/Active Time falls into a time duration, and/or the gap between the start positions of UE DRX on-duration/Active Time/cycle for two UEs is not larger than a threshold in a cell. In some embodiments, the threshold is an offset configured by RRC signaling or L1 signaling, and/or a predefined value. Wherein the threshold is not larger than the value of a cell DTX/DRX parameter. In some embodiments, the cell DTX/DRX parameter includes at least one of the cell DTX/DRX indication information. For example, the threshold is not larger than the value of cell DTX/DRX on-duration or DTX/DRX on-duration timer, and the start positions of UE DRX on-durations are dropped into the cell DTX/DRX on-duration configured or indicated by RRC signaling and/or L1 signaling. FIG. 3 shows an example of alignment of cell DTX/DRX and UE DRX, where UE DRX on durations fall into cell DTX on duration.

In some embodiments, when the UE is configured with UE DRX and cell DTX/DRX, the UE starts UE DRX cycle/on duration timer after UE DRX slot offset from the beginning of the subframe. In some embodiments, the subframe, SFN or the UE DRX slot offset is determined by one or more parameters. In some embodiments, the one or more parameters include at least one of UE ID, UE DRX slot offset, UE DRX start offset, UE DRX short cycle, UE DRX long cycle, SFN, UE DRX on duration timer, cell DTX/DRX start offset, cell DTX/DRX slot offset, cell DTX/DRX cycle, cell DTX/DRX on duration, or an offset. In some embodiments, at least one of the one or more parameters are configured by RRC signaling or L1 signaling.

In some embodiments, the subframe satisfies a function of at least one of parameters. In some embodiments, the one or more parameters include at least one of UE ID, UE DRX slot offset, UE DRX start offset, UE DRX short cycle, UE DRX long cycle, SFN, UE DRX on duration timer, cell DTX/DRX start offset, cell DTX/DRX slot offset, cell DTX/DRX cycle, cell DTX/DRX on duration, or an offset. In some embodiments, the SFN is the subframe number where at least one of the UE DRX on duration timer/cycle or the cell DTX/DRX cycle/on duration timer starts from. In some embodiments, the offset is used to modify at least one of the UE DRX slot offset, UE DRX start offset, cell DTX/DRX start offset, or cell DTX/DRX slot offset.

For example, the subframe (SFN) for the start of cell DTX/DRX on duration/cycle (noted as dtx-Start) is determined by [(SFN× 10)+subframe number] modulo (cell DTX/DRX cycle)=cell DTX/DRX slot offset. Wherein the cell DTX/DRX on duration/cycle is started from the SFN. The offset to modify the UE DRX start offset or slot offset is determined by (SFN+offset) mod T=0, wherein T is UE DRX on duration or UE DRX cycle or cell DTX/DRX on duration. In some embodiments, the new UE DRX start offset or slot offset is determined by a function of the offset and the original UE DRX start offset or slot offset. Wherein the original UE DRX start offset or slot offset is the UE DRX start offset or slot offset in the last recent UE DRX cycle or the UE DRX start offset or slot offset configured by RRC signaling. Wherein the function includes addition, and/or multiplication, and/or subtraction, and/or division and/or XOR, and/or modulo.

For example, the start slot/symbol/time of UE DRX on duration timer/cycle during a cell DTX/DRX on duration is further determined by at least one of UE ID, the number of cell DTX/DRX on duration in a time duration (e.g. a cell DTX/DRX cycle or UE DRX cycle or UE DRX on duration) (N0), the number of UE DRX on duration during a cell DTX/DRX on duration (N1), an index of one or a group of start time of UE DRX on duration timer in a UE DRX on duration (i0), the index of (occasion of) the UE DRX on duration in a cell DTX/DRX on duration (i2), an indication of the number of availability of the start time of UE DRX on duration timer (N3), an index of one or a group of start time of cell DTX/DRX on duration in a UE DRX on duration (i2), or the index of the cell DTX/DRX on duration in a cell DTX/DRX on duration (i2). For example, the index of the start slot/symbol/time of UE DRX on duration timer/cycle=((UEID modN1)*N2+i2) mod N. The UE determines the new slot offset of the UE DRX on duration timer based on the index of the start slot/symbol/time of UE DRX on duration timer/cycle. The UE starts the UE DRX on duration timer after the new slot offset from the beginning of the SFN. Wherein the SFN is the subframe number that cell DTX/DRX on duration/cycle starts.

In some embodiments, the cell DTX/DRX may be regarded at least one of the cell DTX and/or the cell DRX and/or alignment of cell DTX/DRX and UE DRX for one or more base stations (BSs).

In the following paragraphs, many aspects of the cell DTX/DRX are disclosed below.

In some embodiments, when the cell DTX/DRX is configured in a serving cell of a UE, a cell DTX/DRX active time for the serving cell includes at least one of the following:
an active time of the UE DRX for the UE; or
a duration when a timer is running during a cell DTX/DRX cycle; wherein the timer is configured with the cell DTX/DRX; or
a duration when a timer is running during a cell DTX/DRX cycle that is related to HARQ-ACK (hybrid automatic repeat request acknowledgment) information and/or a RACH procedure (random access channel); wherein the timer is configured with the cell DTX/DRX; In some embodiments, the timer configured with cell DTX/DRX comprises at least one of a timer configured with UE CDRX, a timer of cell DTX/DRX on-duration, a timer of cell DTX/DRX for data reception/transmission, a timer of cell DTX/DRX for data retransmission/repetition, a timer of cell DTX/DRX active time, a timer of cell DTX/DRX activation/enabling, a timer of cell DTX/DRX deactivation/disabling, a timer of cell DTX/DRX cycle, or a timer of cell DTX/DRX. or
a duration after the UE reports HARQ-ACK information for a data transmission; or
a duration after the UE reports a NACK (negative acknowledgment) for a data transmission; or
a time duration that starts after the UE reports a NACK for a data transmission and/or ends after the UE receives the data successfully; or
a timer related to a data retransmission which is running during a cell DTX/DRX cycle; or
a timer drx-onDurationTimer or a timer drx-InactivityTimer is running; or
a timer drx-RetransmissionTimerDL, a timer drx-RetransmissionTimerUL or a timer drx-RetransmissionTimerSL is running; or
a duration when the UE is performing a Scheduling Request procedure; or
a Scheduling Request is sent on PUCCH (physical uplink control channel) and/or a Scheduling Request is pending; wherein if this Serving Cell is part of a non-terrestrial network, the Active Time is started after the Scheduling Request transmission that is performed when the SR_COUNTER is 0 for all the SR (Scheduling Request) configurations with pending SR(s) plus the UE-gNB RTT (round trip time); or
the UE is in a time window to monitor an RAR (Random Access Response) and/or receive a MsgB; or
a timer ra-ContentionResolutionTimer or msgB-Response Window is running; or
a PDCCH indicating a new transmission addressed to the C-RNTI (Cell Radio Network Temporary Identifier) of the MAC (Medium Access Control) entity has not been received after a successful reception of a RAR for the Random Access Preamble not selected by the MAC entity among the contention-based Random Access Preamble; or
the cell DTX/DRX on-duration is continuing; or
a second cell DTX/DRX duration is continuing; or
DCI carrying an indication related to a cell DTX/DRX activation or a cell DTX/DRX configuration set is detected and/or the UE applies the indication; or
the UE is performing a RACH procedure during a cell DTX/DRX cycle; or
the UE is waiting for receiving or transmitting a transport block associated with a retransmission; or
a time duration of cell DTX/DRX cycle overlapped with UE CDRX on-duration, and/or the start of UE CDRX on-duration timer is indicated by wake-up indication in DCI format 2-6; or
a time duration of cell DTX/DRX cycle overlapped with UE CDRX active time; or
a time duration of cell DTX/DRX on-duration overlapped with UE CDRX active time; or
a time duration of cell DTX/DRX off-duration overlapped with UE CDRX active time.

In some embodiments, a second cell DTX/DRX duration includes at least one of:
a duration to receive a PDSCH for retransmission; or
a time duration after the end of cell DTX/DRX on-duration; or
a time duration after the detection of a first or a second PDCCH; or
a time duration after the detection of a PDCCH scheduling a PDSCH or PUSCH; or
a time duration after a PDSCH reception or a PUSCH transmission; or
a time duration before the start of a next cell DTX/DRX cycle; or
a time duration before the end of a consecutive duration of UE CDRX active time.

In some embodiments, the cell DTX/DRX off-duration includes at least outside cell DTX/DRX active time, outside of cell DTX/DRX active time, cell DTX/DRX outside-active-time, outside of cell DTX/DRX on-duration, or cell DTX/DRX non active periods.

In some embodiments, in the cell DTX/DRX active time, the UE may:
perform UE behaviors specified during an Active Time of the UE DRX for the UE; or
monitor a first PDCCH and/or a second PDCCH; wherein the CRC of the first PDCCH and/or the second PDCCH is scrambled by a Cell Radio Network Temporary Identifier, C-RNTI, a Cancellation Indication RNTI, CI-RNTI, a Configured Scheduling RNTI, CS-RNTI, an Interruption RNTI, INT-RNTI, a Slot Format Indication RNTI, SFI-RNTI, a Semi-Persistent CSI RNTI, SP-CSI-RNTI, a Transmit Power Control-PUCCH-RNTI, TPC-PUCCH-RNTI, a Transmit Power Control-PUSCH-RNTI, TPC-PUSCH-RNTI, a Transmit Power Control-Sounding Reference Symbols-RNTI, TPC-SRS-RNTI, an Availability Indication RNTI, AI-RNTI, a Sidelink RNTI, SL-RNTI, a Sidelink Configured Scheduling RNTI, SLCS-RNTI or a Sidelink Semi-Persistent Scheduling Vehicle-2-Everything RNTI, V-RNTI; or
monitor a first PDCCH and/or a second PDCCH; or
monitor a first PDCCH and/or a second PDCCH on a SCell (secondary cell) and/or monitor a first PDCCH and/or a second PDCCH for a SCell; or
monitor a RAR or receive a MsgB during a time window; or
perform the ongoing RA (random access) procedure; or
start or restart or keep a first timer running, in which the first timer includes at least one of the followings: timer related to search space set group 1 (SSSG1) or search space set group 1 (SSSG2) for the PDCCH monitoring adaptation, or skipping a duration for the PDCCH monitoring adaptation, or a bwp-InactivityTimer, or a drx-onDurationTimer, or a drx-InactivityTimer, or a drx-RetransmissionTimerDL, or a drx-RetransmissionTimerUL, or a drx-ShortCycleTimer, or a drx-HARQ-RTT-TimerDL, or a drx-HARQ-RTT-TimerUL, or a drx-HARQ-RTT-TimerSL, or a HARQ-RTT-TimerDL-NTN, or a HARQ-RTT-TimerUL-NTN, or drx-RetransmissionTimerUL, or a drx-RetransmissionTimerDL, or a drx-RetransmissionTimerSL, or a drx-RetransmissionTimerDL-PTM, or the timer configured with cell DTX/DRX; In some embodiments, the timer configured with cell DTX/DRX comprises at least timer configured with UE CDRX, a timer of cell DTX/DRX on-duration, a timer of cell DTX/DRX for data reception/transmission, a timer of cell DTX/DRX for data retransmission/repetition, a timer of cell DTX/DRX active time, a timer of cell DTX/DRX activation/enabling, a timer of cell DTX/DRX deactivation/disabling, a timer of cell DTX/DRX cycle or a timer of cell DTX/DRX; or
start or restart or keep performing a first PDCCH monitoring during a first timer is running; or
perform UE behaviors during a UE CDRX active time during a time duration; wherein the time duration comprises at least one of:
a) a time duration of a cell DTX/DRX cycle overlapped with a UE CDRX (Connected Mode Discontinuous Reception) on-duration, and/or the start of the UE CDRX on-duration timer is indicated by a wake-up indication in DCI format 2-6; or
b) a time duration of a cell DTX/DRX cycle overlapped with a UE CDRX active time; or
c) a time duration of a cell DTX/DRX on-duration overlapped with a UE CDRX active time; or
d) a time duration of a cell DTX/DRX off-duration overlapped with a UE CDRX active time; or
an SRS (Sounding Reference Signal) transmission; or
receive a common and broad channel/signal; or
perform CSI measurement; or
perform CSI (channel status information) reporting; or
a PUCCH (physical uplink control channel) transmission and/or PUSCH reception and/or PDSCH (physical downlink shared channel) reception.

In some embodiments, when the cell DTX/DRX is configured, the cell DTX/DRX outside-active-time for a serving cell includes at least one of:
the cell DTX/DRX off-duration; or
the time duration that is not during the cell DTX/DRX active time; or
the time duration that is not during UE DRX active time; or
outside UE DRX active time.

In some embodiments, during the outside cell DTX/DRX active time, the UE may:
not transmit an SRS; or
not report CSI; or
not transmit on UL-SCH; or
not transmit on RACH; or
not monitor a first PDCCH; or
not monitor a first PDCCH on a SCell and/or not monitor a first PDCCH for a SCell; or
not transmit a PUCCH; or
not receive a DL-SCH (downlink shared channel); or
cancel the ongoing Random Access procedure; or
stop running of a first timer; or
receive a semi-persistent scheduling, SPS, physical downlink shared channel, PDSCH, reception; or
transmit a configured grant, physical uplink shared channel, PUSCH.

In some embodiments, the UE monitors a PDCCH carrying scheduling information for the DL during the cell DTX on-duration, active time, or cycle. In some embodiments, the UE monitors the PDCCH carrying scheduling information for the UL during the cell DRX on-duration, active time, or cycle.

In some embodiments, when the UE is configured with the cell DTX, the cell DTX functionality controls a first UE behavior according to certain requirements, and/or a first BS behavior according to the certain requirements.

In some embodiments, the first UE behavior includes a measurement based on a reference signal (RS) or common signals/channels, a first PDCCH (physical downlink control channel) monitoring, an SPS (semi-persistent scheduling) PDSCH (physical downlink shared channel) reception, and/or a PDSCH reception, and/or the reception associated with a RACH procedure.

In some embodiments, the RS includes a periodic CSI-RS, and/or a semi-persistent CSI-RS, and/or an aperiodic CSI-RS, and/or remote interference management RS (RIM-RS), and/or positioning RS (PRS), and/or SS/PBCH block, and/or phase-tracking RS (PT-RS), and/or secondary synchronization signal (SSS), and/or primary synchronization signal (PSS).

In some embodiments, the first PDCCH monitoring includes monitoring a first PDCCH that is the PDCCH carrying DL scheduling information, and/or is the PDCCH carrying at least one of a DCI format 1-0, DCI format 1-1, DCI format 1-2, DCI format 2-0, DCI format 2-1, DCI format 2-2, DCI format 2-3, DCI format 2-4, DCI format 2-5, DCI format 2-6, and/or DCI format 2-7.

In some embodiments, the certain requirements include at least one of the followings:
the UE is in a cell DTX active time;
the UE is in a cell DTX on-duration;
the UE is in a cell DTX cycle; or
the UE is in the duration of a cell DTX on-duration or active time overlapped with a UE DRX on-duration or active time; or
the UE reports a NACK of HARQ-ACK information for PDSCH reception; or
the UE detects a PDCCH with scheduling information for a data retransmission; or
the UE sends a SR; or
the UE performs RACH procedure.

In some embodiments, the first BS behavior includes common signal/channels or RS transmission and/or the PDCCH or PDSCH transmission and/or the transmission associated with the RACH procedure.

In some embodiments, the UE performs DL reception associated with a first UE behavior or BS performs DL transmission associated with a first BS behavior during the cell DTX active time or the cell DTX on-duration. Wherein the UE stops performing DL reception associated with a first UE behavior or BS stops performing DL transmission associated with a first BS behavior during outside of the cell DTX active time (also refer to as the cell DTX outside-active-time) or the cell DTX on-duration.

In accordance with an embodiment, when the UE is configured with the cell DRX, the cell DRX functionality controls a second UE behavior according to certain requirements (see below some example requirements), and/or a second BS behavior according to the certain requirements.

In some embodiments, the second UE behavior includes SRS transmission, and/or a second PDCCH monitoring, and/or SR (scheduling request) transmission, and/or CG-PUSCH transmission (Configured grant-PUSCH), and/or PUCCH/PUSCH transmission, and/or the transmission associated with RACH procedure.

In some embodiments, the second PDCCH monitoring is monitoring a second PDCCH that is the PDCCH carrying UL scheduling information, and/or is the PDCCH carrying at least one of DCI format 0-0, DCI format 0-1, DCI format 0-2, DCI format 2-0, DCI format 2-1, DCI format 2-2, DCI format 2-3, DCI format 2-4, DCI format 2-5, DCI format 2-6, and/or DCI format 2-7.

In some embodiments, the certain requirements include at least one of the following: the UE is in the cell DRX active time; the UE is in the cell DRX on-duration; the UE is in the cell DRX cycle; the UE is in the duration of the cell DRX on-duration or active time overlapped with the UE DRX on-duration or active time; the UE reports a NACK of HARQ-ACK information for PDSCH reception; the UE detects a PDCCH with scheduling information for a data retransmission; the UE sends a SR; or the UE performs RACH procedure.

In some embodiments, the second BS behavior includes the reception for a report of HARQ-ACK feedback or the measurement result of RSRP/RSRQ/RSSI/CQI, SRS, PUCCH/PUSCH, or the transmission associated with RACH procedure.

In some embodiments, the UE performs UL transmission associated with a second UE behavior or the BS performs UL reception associated with a second BS behavior during the cell DRX active time or the cell DRX on-duration. In some embodiments, the UE stops UL transmission associated with a second UE behavior or the BS stops UL reception associated with a second BS behavior during a duration outside of the cell DRX active time (also refer to as the cell DRX outside-active-time) or the cell DRX on-duration.

In accordance with an embodiment, when UE is configured with the cell DTX or the cell DRX, the cell DTX/DRX controls a third UE behavior according to certain requirements.

In some embodiments, the third UE behavior comprises UE behavior in the UE DRX Active Time or a timer behavior or a first UE behavior or a second UE behavior.

In some embodiments, the UE performs a third UE behavior during the cell DTX/DRX active time and/or the cell DTX/DRX on-duration and/or Active Time of the UE DRX.

In some embodiments, the UE stops UL transmission associated with a second UE behavior or BS stops UL reception associated with a second BS behavior during a duration outside of the cell DRX active time or the cell DRX on-duration. In some embodiments, the UE stops DL transmission associated with a first UE behavior or BS stops DL reception associated with a first BS behavior during a duration outside of the cell DTX active time or the cell DTX on-duration. In some embodiments, the timer behavior is the start or restart or running or stopping of the timer configured with the UE DRX or timer configured with cell DTX/DRX.

In some embodiments, the cell DTX/DRX functionality does not control the timer behavior.

In some embodiments, the cell DTX/DRX functionality may control the third UE behavior associated with timer behavior.

In some embodiments, the cell DTX configuration information is associated with search space set configuration for DL data transmission and/or UE behaviors associated with the DL procedure. In some embodiments, the search space set configuration may include PDCCH monitoring occasions for the detection of DCI format 1-0 and/or DCI format 1-1 and/or DCI format 1-2 and/or DCI format 3-1 and/or DCI format 2-0 and/or DCI format 2-1 and/or DCI format 2-2 and/or DCI format 2-3 and/or DCI format 2-4 and/or DCI format 2-5 and/or DCI format 2-6 and/or DCI format 2-7.

In some embodiments, the cell DRX configuration information is associated with search space set configuration for UL data transmission and/or UE behaviors associated with UL procedure. In some embodiments, the search space set configuration may include PDCCH monitoring occasions for the detection of DCI format 0-0 and/or DCI format 0-1 and/or DCI format 0-2 and/or DCI format 3-0 and/or DCI format 2-0 and/or DCI format 2-1 and/or DCI format 2-2 and/or DCI format 2-3 and/or DCI format 2-4 and/or DCI format 2-5 and/or DCI format 2-6 and/or DCI format 2-7.

In some embodiments, the search space set configuration may include UE-specific search space set and/or Type3-common search space set.

In accordance with an embodiment, the UE behavior(s) defined in the cell DTX/DRX on-duration or off period not changing by any of timers related to the UE DRX operations.

In accordance with an embodiment, the cell DTX/DRX disclosed above being used for the RRC connected mode UE.

In accordance with an embodiment, the UE DRX disclosed above being used for the RRC connected mode UE and/or being CDRX functionality.

In accordance with an embodiment, the cell DTX/DRX off-duration or the cell DTX/DRX outside-active-time include the time duration that is not during the cell DTX/DRX active time or the cell DTX/DRX on-duration.

In accordance with an embodiment, the cell DTX/DRX on-duration being configured as a cell DTX/DRX on-duration timer.

In accordance with an embodiment, the cell DTX/DRX inactivity timer is configured by RRC signaling, which is started or restarted when a PDCCH with data scheduling information is detected by a UE, or a HARQ-ACK information is fed back by a UE, or a cell DTX/DRX on-duration timer is stopped, or a RACH procedure or SR procedure is occurred/ongoing, or a DCI indicating an information triggering the start or restart of the cell DTX/DRX inactivity timer.

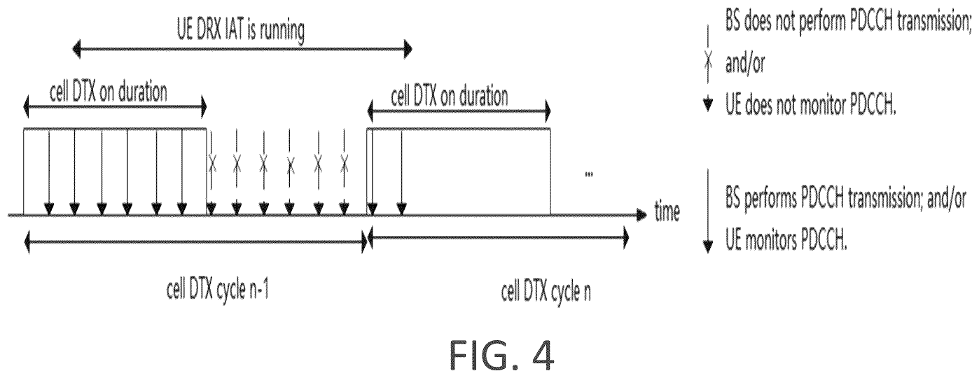

FIG. 4 illustrates an example in that the cell DTX/DRX is relevant to the third UE behavior when the timer is running but does not control the timer behavior in accordance with an embodiment. In this example, the UE does not monitor PDCCH during the UE DRX Inactivity timer (IAT) running if BS and/or the UE is in the cell DTX off-duration.

In some embodiments, both the cell DTX cycle and the DRX cycle the cell DTX have the same definition and represent the duration for periodic the cell DTX/DRX operation or one or more cycles for DTX/DRX operation.

In some embodiments, the cycle of the cell DTX/DRX or the UE DRX is the periodicity or a time period for the cell DTX/DRX or the UE DRX.

In some embodiments, higher layer parameter represents the MAC CE and/or RRC signaling.

In some embodiments, the cell DTX/DRX represents the cell DTX and the cell DRX, and/or the cell DTX, and/or the cell DRX, and/or alignment of cell DTX/DRX and UE DRX.

In some embodiments, the base station (BS) may mean a communication node, or BTS (Base Transceiver Station) in 2G, or NodeB in 3G, or eNB (E-UTRAN NodeB/enhanced NodeB) in 4G, or gNB in 5G, or a base station of LTE (Long term evolution) or NR (New Radio access technology), or a base station of further generation communication system, or a cell with a normal state or activated state or deactivated state or dormant state, or a cell providing basic coverage, or a cell boosting capacity, or a small cell, or a primary cell, or a secondary cell.

In accordance with an embodiment, the cell DTX/DRX indication information, design of DCI indicating the cell DTX/DRX indication information, application of the cell DTX/DRX indication information and detection of DCI are disclosed as follows.

### The Cell DTX/DRX Indication Information

In accordance with an embodiment, a DCI includes the cell DTX/DRX indication information. In some embodiments, the cell DTX/DRX indication information may at least one of the following indication parameters:
1—The cell DTX activation indicator. In some embodiments, the indication information indicates activating cell DTX operation according to a cell DTX pattern or a cell DTX periodicity/cycle or activating cell DTX functionality. Wherein a cell DTX pattern or a cell DTX periodicity/cycle corresponds to one or more cell DTX configuration information. Wherein the one or more cell DTX configuration information is configured by higher layer parameters.
2—The cell DTX deactivation indicator. In some embodiments, the indication information indicates deactivating cell DTX operation according to a cell DTX pattern or a cell DTX periodicity/cycle or deactivating cell DTX functionality. Wherein a cell DTX pattern or a cell DTX periodicity/cycle corresponds to one or more cell DTX configuration information. Wherein the one or more cell DTX configuration information is configured by higher layer parameters.
3—The cell DRX activation indicator. In some embodiments, the indication information indicates activating cell DRX operation according to a cell DRX pattern or a cell DRX periodicity/cycle or a DRX functionality. Wherein a cell DRX pattern or a cell DRX periodicity/cycle corresponds to one or more cell DRX configuration information. Wherein the one or more cell DRX configuration information is configured by higher layer parameters.
4—The cell DRX deactivation indicator. In some embodiments, the indication information indicates deactivating cell DRX operation according to a cell DRX pattern or a cell DRX periodicity/cycle or a cell DRX functionality. Wherein a cell DRX pattern or a cell DRX periodicity/cycle corresponds to one or more cell DRX configuration information. Wherein the one or more cell DRX configuration information is configured by higher layer parameters.
5—The cell DTX on-duration enabling and/or disabling indicator. In some embodiments, the indication information indicates starting and/or stopping cell DTX on-duration timer, or starting and/or stopping cell DTX on-duration, or enable and/or disable the availability of cell DTX on-duration. In some embodiments, the indication information indicates a number of symbols/slots during a time duration and/or all zeros symbols/slots during a time duration as cell DTX on-duration. Wherein a time duration is one or more mini-slots or slots or subframes or frames or milliseconds.
6—The cell DRX on-duration enabling and/or disabling indicator. In some embodiments, the indication information indicates starting and/or stopping cell DRX on-duration timer, or starting and/or stopping cell DRX on-duration, or enable and/or disable the availability of cell DRX on-duration. In some embodiments, the indication information indicates a number of symbols/slots during a time duration and/or all zeros symbols/slots during a time duration as cell DRX on-duration. Wherein a time duration is one or more mini-slots or slots or subframes or frames or milliseconds.
7—The cell DTX off-duration enabling and/or disabling indicator. In some embodiments, the indication information indicates starting and/or stopping cell DTX off-duration timer, or starting and/or stopping cell DTX off-duration, or enable and/or disable the availability of cell DTX off-duration. In some embodiments, the indication information indicates a number of symbols/slots during a time duration and/or all zeros symbols/slots during a time duration as cell DTX off-duration. Wherein a time duration is one or more mini-slots or slots or subframes or frames or milliseconds.
8—The cell DRX off-duration enabling and/or disabling indicator. In some embodiments, the indication information indicates starting and/or stopping cell DRX off-duration timer, or starting and/or stopping cell DRX off-duration, or enable and/or disable the availability of cell DRX off-duration. In some embodiments, the indication information indicates a number of symbols/slots during a time duration and/or all zeros symbols/slots during a time duration as cell DRX off-duration. Wherein a time duration is one or more mini-slots or slots or subframes or frames or milliseconds.

For example, the last four options may include activating/deactivating a configuration information of one or multiple cell DTX/DRX on/off-durations, or activating/deactivating the cell DTX/DRX operation for one or multiple cell DTX/DRX on/off-durations.

9—The cell DTX/DRX switching indicator. In some embodiments, the indication information indicates the configuration information of the cell DTX/DRX switched between two or multiple sets/candidate values of cell DTX/DRX configuration information and/or cell DTX/DRX parameters and/or cell DTX/DRX indication information. In some embodiments, the indication information indicates the cell DTX/DRX pattern switched between two or multiple cell DTX/DRX patterns. Wherein cell DTX/DRX pattern is based on/according to a set of cell DTX/DRX configuration information. In some embodiments, a set of cell DTX/DRX configuration information is configured by higher layer parameters. In some embodiments, the cell DTX/DRX switching indicator may be used to indicating a switch of some parameters, such as values of the start offset of the UE CDRX cycle, or set IDs of configuration sets, or the cell DTX/DRX switching indicators between two cell configuration patterns. In some embodiments, the indication information indicates the cell DTX/DRX pattern switched between a cell DTX/DRX pattern and a normal mode without cell DTX/DRX pattern.

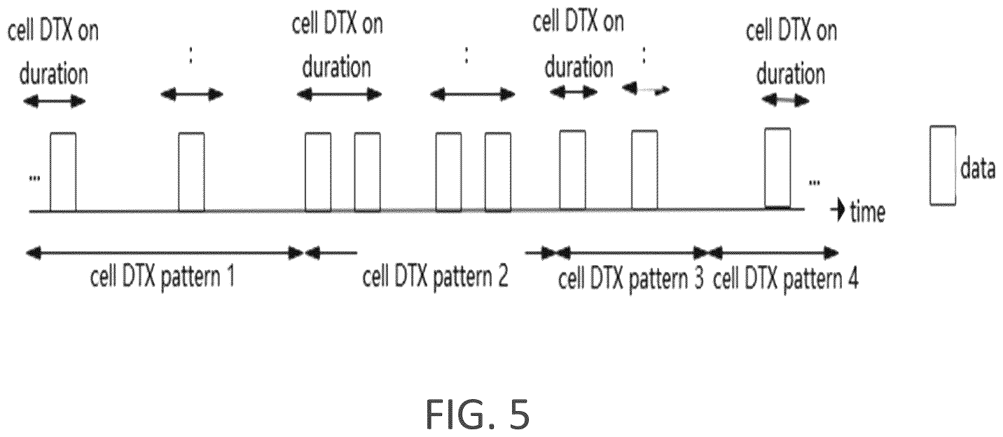

FIG. 5 shows an example of the cell DTX/DRX switching indicator indicating switching the cell DTX/DRX pattern between multiple cell DTX patterns.

10-Skipping one or multiple cell DTX/DRX on-durations. In some embodiments, the indication information indicates the UE to skip performing UE behavior during cell DTX/DRX on-duration. For example, UE behavior includes at least one of the first UE behavior or the second UE behavior or a third UE behavior during cell DTX/DRX on-duration or UE behavior in cell DTX/DRX active time.

11-Skipping one or multiple cell DTX/DRX cycles. In some embodiments, the indication information indicates the UE to skip performing UE behavior during cell DTX/DRX cycle.

12-Skipping one or multiple cell DTX/DRX off-durations. In some embodiments, the indication information indicates the UE to skip performing UE behavior during cell DTX/DRX off-duration.

13-Skipping the cell DTX/DRX for a time duration. In some embodiments, the indication information indicates the UE skips performing UE behavior for a time duration. Wherein the time duration includes at least one of the cell DTX/DRX on-duration/active time/cycle/non active period/outside cell DTX/DRX active time. For example, UE behavior includes at least one of the first UE behavior or the second UE behavior or a third UE behavior during cell DTX/DRX on-duration or UE behavior in cell DTX/DRX active time.

For example, the above options may include skipping or deactivating one or multiple cell DTX/DRX on-durations/cycles/off-durations. For example, the UE does not perform PDCCH monitoring during one or multiple cell DTX on-durations according to the skipping one or multiple cell DTX/DRX on-durations. For example, the UE does not perform the cell DTX operation during one or multiple cell DTX cycles. For example, the UE performs PDCCH monitoring during one or multiple cell DTX off-durations.

14—The UE DRX indication information. In some embodiments, the UE DRX indication information includes at least one of the following:
a. enable/disable the UE DRX functionality for a time duration. In some embodiments, the enable/disable of the UE DRX functionality for a time duration includes that the UE activates/deactivates the UE DRX function or performs or stops the UE DRX operation for a time duration. In some embodiments, the enable/disable of the UE DRX functionality for a time duration includes that the UE assumes that the UE DRX function is valid/invalid or available/unavailable for a time duration. In some embodiments, the time duration includes one or more UE DRX cycles, or the time duration is smaller than a UE DRX cycle, or the time duration is one or more UE DRX on-durations, or the time duration is configured by higher layer parameter.
b. the UE DRX activation/deactivation, where it indicates activating/deactivating the UE DRX function or performs or stops the UE DRX operation.
c. enable/disable one or multiple UE DRX cycles;
d. enable/disable one or multiple UE DRX on-durations;
e. the start offset of the UE DRX cycle;
f. offset of the cell DTX/DRX and the UE DRX cycle or on-duration, which is used to determine the time interval between the cell DTX/DRX cycle and the UE DRX cycle, or the cell DTX/DRX on-duration and the UE DRX on-duration;
g. the cycle of the UE DRX;
h. offset to determine the start offset of the UE DRX on-duration or UE DRX cycle; In some embodiments, the offset is a minimum gap between two adjacent start positions of UE DRX on-duration/cycle for the UEs in a cell or a cell group. In some embodiments, the offset is used to modify the value of start offset of the UE DRX on-duration/cycle. In some embodiments, the offset is indicated by a bit-field in a DCI. Wherein the bit width of the bit-field is n which can indicates 2∧n kinds of values of offset. In some embodiments, the candidate values of offset are configured by higher layer parameter. Wherein the bit-field of a DCI indicates the entry of the candidate values. In some embodiments, the start offset of UE DRX on-duration/cycle is noted as m binary bits and the bit-field of a DCI indicates an entry of a m binary-bit offset among 2∧m kinds of m binary-bit offset values. For example, the start offset of UE DRX on-duration is configured as 1 ms (noted as ‘00001’ binary number) and the DCI indicates a value of 1 which corresponds to an offset value of ‘00011’. The UE determines the modified start offset of UE DRX on-duration/cycle as ‘00100’ which obtained by a binary addition of ‘00001’ and ‘00011’, or the UE determines the modified start offset of UE DRX on-duration/cycle as ‘00010’ which obtained by XOR of ‘00001’ and ‘00011’. In some embodiments, the DCI is a L1 signaling that is used to indicate the cell DTX/DRX indication information.

i. the start of a timer and/or the start of UE DRX on duration/Active Time/cycle; wherein the indication information includes the start offset of at least one of the first timer or at least one of the first timer started after a delay/slot offset from the current subframe or the slot for the detection of the PDCCH carrying the indication.

j. one or multiple configuration sets for the UE DRX; wherein the indication information includes at least one of the above parameters of the UE DRX and/or set indexes/identities/identifiers of one or multiple configuration sets.

In accordance with an embodiment, the configuration set for the UE DRX includes at least one of the following parameters: set ID, offset, start offset, the UE DRX cycle, the UE DRX on-duration timer, the UE DRX off-duration, the UE DRX inactivity timer. In some embodiments, the start offset includes at least one of the start offset for the UE DRX cycle and/or the start offset for the UE DRX on-duration.

15-Enable/disable the cell DTX/DRX functionality for a time duration. In some embodiments, the enable/disable the cell DTX/DRX functionality for a time duration includes that the UE activates/deactivates the cell DTX/DRX function or performs or stops the cell DTX/DRX operation for a time duration. In some embodiments, the enable/disable the cell DTX/DRX functionality for a time duration includes that the UE assumes that the cell DTX/DRX function is valid/invalid or available/unavailable for a time duration. In some embodiments, the time duration includes one or more cell DTX/DRX cycles, or the time duration is smaller than a cell DTX/DRX cycle, or the time duration is one or more cell DTX/DRX on-durations, or the time duration is configured by higher layer parameter.

16-Enable/disable one or multiple cell DTX/DRX cycles. In some embodiments, the indication information includes activating/deactivating a configuration information of one or multiple cell DTX/DRX cycles, or activating/deactivating the cell DTX/DRX operation for one or multiple cell DTX/DRX cycles.

17-Enable/disable one or multiple cell DTX/DRX on-durations. In some embodiments, the indication information includes activating/deactivating a configuration information of one or multiple cell DTX/DRX on-durations, or activating/deactivating the cell DTX/DRX operation for one or multiple cell DTX/DRX on-durations.

18—The availability of a cell DTX/DRX cycle. In some embodiments, the configuration information includes activating a configuration information of a cell DTX/DRX cycle, or assuming that the cell DTX/DRX operation is available for a cell DTX/DRX cycle.

19—The start of the cell DTX/DRX cycle. In some embodiments, the configuration information is used to determine the start of the cell DTX/DRX cycle.

20—The cycle of the cell DTX/DRX. In some embodiments, the configuration information is used to determine the time period or periodicity of a cell DTX/DRX cycle. In some embodiments, the cell DTX/DRX cycle is periodic.

21—The cell DTX/DRX on-duration of the cell DTX/DRX cycle. In some embodiments, the configuration information is used to determine the time duration of the cell DTX/DRX on-duration during a cell DTX/DRX cycle.

22-Long the cell DTX/DRX cycle. In some embodiments, the configuration information is used to determine the time duration of a long cell DTX/DRX cycle.

23-Short the cell DTX/DRX cycle. In some embodiments, the configuration information is used to determine the time duration of a short cell DTX/DRX cycle. In some embodiments, a short cell DTX/DRX cycle is configured together with a long cell DTX/DRX cycle. In some embodiments, a short cell DTX/DRX cycle timer is used to determine the duration the UE may follow the short cell DTX/DRX cycle.

24-enable/disable signal transmission and/or reception. In more detail:
a. the configuration information may include a flag to enable/disable the signal transmission and/or reception; and/or
b. when the configuration information of “enable/disable signal transmission and/or reception” is configured, the signal transmission and/or reception may be enabled, or the signal may be transmitted and/or received. If the configuration information of “enable/disable signal transmission and/or reception” is not configured, the signal transmission and/or reception may not be enabled or disabled, or the signal may not be transmitted and/or received.
c. the signal includes reference signals (e.g., SRS, CSI-RS, etc.), UCI, PUCCH, SR, and/or PDCCH and so on. In some embodiments, the signal is a signal related to the UL and/or DL procedures. In some embodiments, the signal is transmitted and/or received during the cell DTX/DRX on-duration, the cell DTX/DRX active time, the cell DTX/DRX cycle and/or the cell DTX/DRX off-duration, the cell DTX/DRX outside-active-time and/or during a duration that is not the cell DTX/DRX on-duration, the cell DTX/DRX active time and/or the cell DTX/DRX cycle.
d. Wherein this configuration information is applied for the cell DTX/DRX on-duration, the cell DTX/DRX active time, the cell DTX/DRX cycle and/or the cell DTX/DRX off-duration, the cell DTX/DRX outside-active-time.
e. The content/interpretation of this indication information is related to the type of reference signal, the type of link direction for signal (e.g., uplink and downlink), the type of signaling to indicate this indication information (e.g., L1 signaling, MAC CE, and RRC signaling). In some embodiments, the content/interpretation is different from the type of signals. For example, if the signal transmission and/or reception is configured by RRC signaling, this indication information includes whether the signal may be transmitted and/or received or not, and/or where the signal may be transmitted and/or received, and/or how to transmit and/or receive the signal, and/or transmit and/or receive the signal based on the indication information of a DCI.

25-Offset. For example, the offset is:
a. the start offset that is used to determine the start of the cell DTX/DRX cycle, and/or
b. used to determine the start of the cell DTX on-duration, or the cell DTX active time, or the cell DRX cycle, or the cell DRX on-duration, or the cell DRX active time, and/or
c. used to determine the length of time interval between the start of the cell DTX cycle and the cell DRX cycle, or the interval between the start of the cell DTX on-duration and the cell DRX on-duration.
d. used to determine the length of time interval between the start of the cell DTX/DRX cycle and the UE DRX cycle, or the interval between the start of the cell DTX/DRX on-duration and the UE DRX on-duration.

In some embodiments, an offset, that is the minimum length of time interval between the start position of the cell DTX cycle and the cell DRX cycle or between the start position of the cell DTX on-duration and the cell DRX on-duration, can be configured by higher layer parameter.

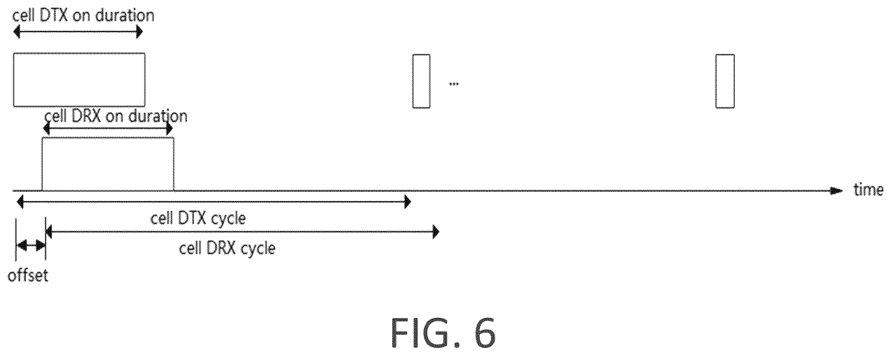

FIG. 6 illustrates an example of an offset between the start of the cell DTX on-duration/the cell DTX cycle and the cell DRX on-duration/the cell DRX cycle according to an embodiment of the present disclosure.

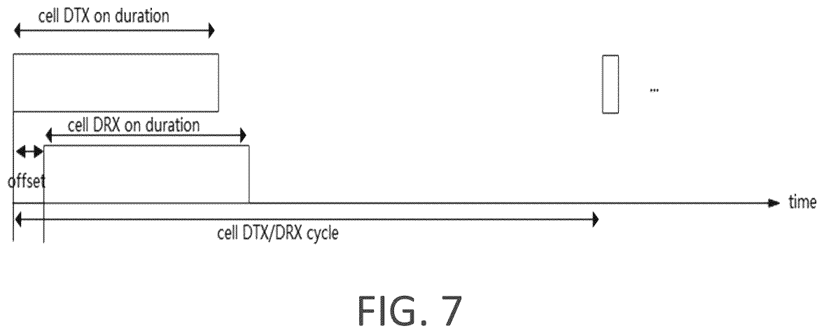

FIG. 7 illustrates an example of an offset between the start of the cell DTX on and the cell DRX on-duration within the same cell DTX/DRX cycle according to an embodiment of the present disclosure.

In some embodiments, the offset is used to determine the start position of the cell DTX cycle or the cell DRX cycle.

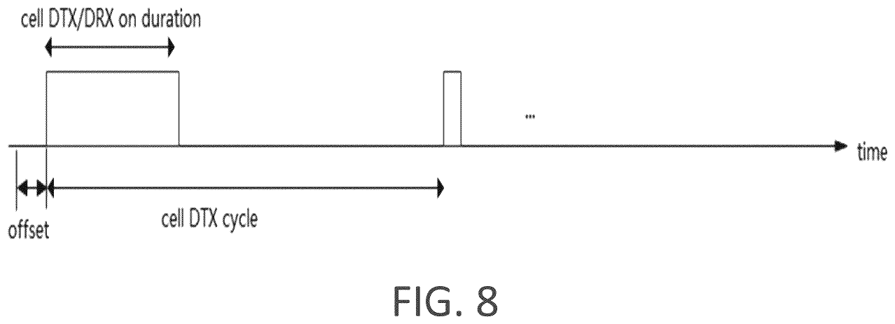

FIG. 8 illustrates an example of an offset used to determine the start of the cell DTX cycle, or the start of the cell DTX/DRX on-duration according to an embodiment of the present disclosure.

26—The starting position of the cell DTX/DRX indication information in a L1 signaling; wherein the L1 signaling is DCI format 2-6 or DCI format 0-1 or 0-2 or 1-1 or 1-2 or a new DCI format for a group of UEs.

27—The cell DTX and/or the cell DRX activation/deactivation for a group of cell.

28-A set of candidate values of at least one of the above indication information.

29-One or multiple configuration sets for the cell DTX/DRX. In some embodiments, the indication information of “one or multiple configuration set for the cell DTX/DRX” includes at least one of the above parameters of the cell DTX/DRX and/or set indexes/identities/identifiers of one or multiple configuration sets. In some embodiments, the configuration set for the cell DTX and/or the cell DRX includes at least one of the following parameters: set ID, offset, start offset, the cell DTX and/or the cell DRX cycle, the cell DTX and/or the cell DRX on-duration, the cell DTX and/or the cell DRX off-duration, the cell DTX and/or the cell DRX inactivity timer. In some embodiments, the start offset includes at least one of the start offset for the cell DTX/DRX cycle and/or the start offset for the cell DTX/DRX on-duration.

30—The cell DTX configuration set identifier.

31—The cell DRX configuration set identifier.

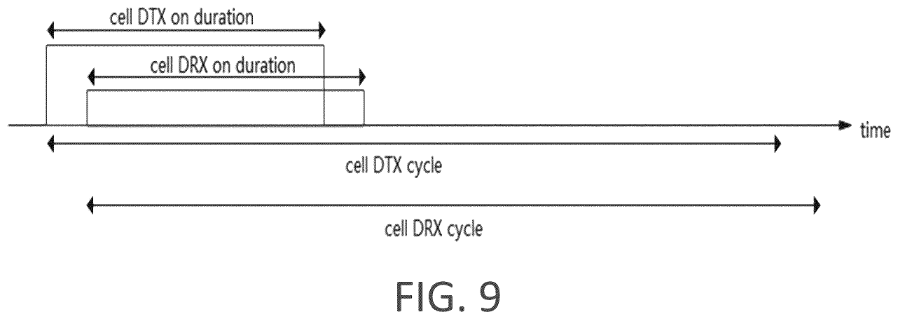

FIG. 9 shows an example where parameters of start offset, cycle and on-duration in the configuration sets for the cell DTX and the cell DRX are configured separately according to an embodiment of the present disclosure.

In some embodiments, the candidate values of at least one of the parameters in the configuration set(s) for the cell DTX and the cell DRX are the same.

In some embodiments, the candidate values of at least one of the parameters in the cell DTX configuration set and the cell DRX configuration set are the same.

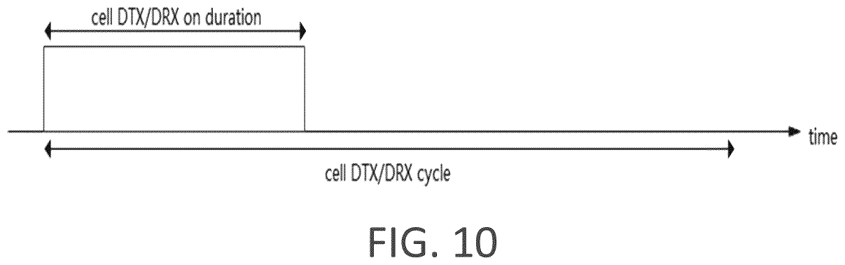

FIG. 10 shows an example where parameters of cycle, start offset and on-duration in the configuration sets for the cell DTX and the cell DRX are configured as the same value according to an embodiment of the present disclosure.

In some embodiments, the parameters of configuration set for the cell DTX includes at least one of the parameters of the configuration for the cell DRX operation, and vice versa.

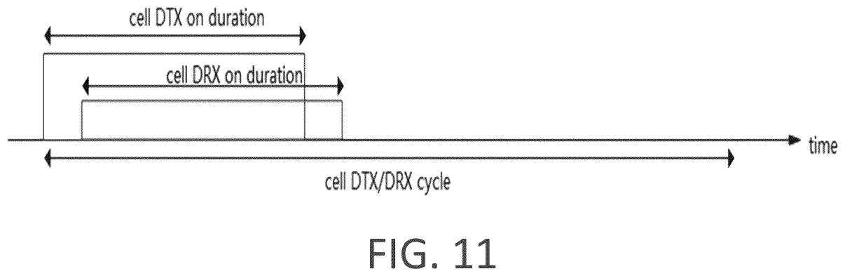

FIG. 11 shows an example where parameters of cycle and the start offset of the cycle in the configuration sets for the cell DTX are used for the cell DRX operation according to an embodiment of the present disclosure.

In some embodiments, at least one of the parameters of the configuration set for the cell DTX/DRX are used for both the cell DTX operation and the cell DRX operation. In some embodiments, the at least one of the parameters include start offset, and/or a cycle for the cell DTX/DRX, and/or on-duration for the cell DTX/DRX.

In some embodiments, the cell DTX/DRX pattern is determined based on at least one of the cell DTX/DRX indication information/configuration information. For example, the cell DTX/DRX pattern is determined by a start offset and a cell DTX/DRX on-duration/cell DTX/DRX on-duration timer configured by higher layer parameters and/or L1 signaling. For example, the cell DTX/DRX pattern is determined by a start offset, a cell DTX/DRX periodicity, and a cell DTX/DRX on-duration/cell DTX/DRX on-duration timer configured by higher layer parameters and/or L1 signaling. For example, the cell DTX/DRX pattern is determined by a start offset, a cell DTX/DRX periodicity, a cell DTX/DRX on-duration/cell DTX/DRX on-duration timer and/or UE DRX parameters including at least one of the UE DRX on-duration timer, start offset and UE DRX periodicity configured by higher layer parameters and/or L1 signaling.

In some embodiments, the cell DTX/DRX pattern includes a pattern corresponding to a configuration that the value of cell DTX/DRX on-duration timer or the length of cell DTX/DRX on-duration is equal to the value of cell DTX/DRX periodicity or the cell DTX/DRX cycle.

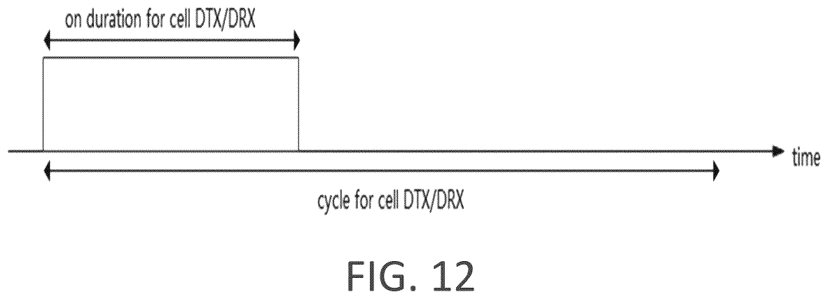

FIG. 12 shows an example where parameters of start offset, on-duration and cycle in the configuration sets for the cell DTX and the cell DRX are used for both the cell DTX and the cell DRX operations.

In some embodiments, the UE DRX indication information includes at least one of the start offset, drx-onDuration timer, DRX cycle, timers related to data retransmission during a DRX cycle.

In some embodiments, the DCI indicates a UE to stop performing the cell DTX/DRX operation or deactivate a cell DTX/DRX according to the cell DTX/DRX configuration with a first set ID or start performing the cell DTX/DRX operation or activate a cell DTX/DRX according to the cell DTX/DRX configuration with a second set ID.

In some embodiments, the DCI indicates a UE to stop performing the cell DTX/DRX operation or deactivate a cell DTX/DRX according to the cell DTX/DRX configuration with a first set ID and start performing the cell DTX/DRX operation or activate a cell DTX/DRX according to the cell DTX/DRX configuration with a second set ID.

In some embodiments, the UE applies the indication of the cell DTX/DRX after the detection of the DCI carrying the indication of the cell DTX/DRX.

In some embodiments, the cell DTX/DRX indication information further includes at least one of the followings:
a number of cell DTX/DRX on duration in a time duration. The indication information indicates the number of cell DTX/DRX on duration in a cell DTX/DRX cycle or UE DRX cycle or UE DRX on duration;
a number of occasions for UE DRX on duration in a timer duration. The indication information indicates the number of occasions for UE DRX on duration during a cell DTX/DRX on duration/cycle;
an index of one or a group of the start time of UE DRX on duration timer during occasions for UE DRX on duration. In some embodiments, there is one or more start time of UE DRX on duration timer during an occasion for UE DRX on duration. In some embodiments, the indication information indicates the index of the start time of UE DRX on duration timer during occasions for UE DRX on duration.
an index of (occasions of) the UE DRX on duration in a cell DTX/DRX on duration. In some embodiments, there are one or more UE DRX on durations during a cell DTX/DRX on duration.
an indication of the availability of UE DRX on duration timer. In some embodiments, there are a number of start time of the UE DRX on duration timer. The indication information indicates the number of the availability of UE DRX on duration timer during a time duration.
an indication of a number of availability of the start time of UE DRX on duration timer. In some embodiments, there are a number of available start time of the UE DRX on duration timer during a time duration. The indication information indicates the number of availability of the start time of UE DRX on duration timer during a time duration.
an indication of the availability of the start time of cell DTX/DRX on duration during a time duration. For example, the indication information indicates the availability of the start time of cell DTX/DRX on duration or the availability of one or more occasions for cell DTX/DRX on duration during a time duration.
an index of one or a group of start time of cell DTX/DRX on duration during a time duration. In some embodiments, the time duration includes at least one of the UE DRX cycle, UE DRX on duration, UE DRX Active Time, cell DTX/DRX cycle, cell DTX/DRX on duration, or cell DTX/DRX off duration.
an index of the cell DTX/DRX on duration in a cell DTX/DRX on duration.

### Signaling Indicating the Cell DTX/DRX Indication Information

In accordance with an embodiment, when the UE is configured with the cell DTX/DRX, the UE can be triggered by a L1/L2 signaling to indicate the cell DTX/DRX indication information.

In accordance with an embodiment, the cell DTX/DRX indication information is triggered by L1 signaling.

In some embodiments, when the cell DTX/DRX indication information is triggered by L1 signaling, the cell DTX/DRX indication information is indicated by DCI format 2-6.

In some embodiments, the start bit location of the cell DTX/DRX indication information is immediately after the SCell dormancy indication field and/or wake-up indication field.

In some embodiments, the field of the cell DTX/DRX indication information indicates at least one of the cell DTX/DRX indication information.

In some embodiments, the size of the field of the cell DTX/DRX indication information is equal to the number of the cell DTX/DRX indication information, or rounding up the value of log 2(I), or the number of cells configured for the UE. Here, I represents the number of candidate values of the cell DTX/DRX indication information. In some embodiments, at least one of the cells are configured with the cell DTX/DRX.

In some embodiments, the field of the cell DTX/DRX indication information is a bitmap with a size equal to the number of UEs in a group or the number of groups of UEs or a number of cell groups. For example, each bit of the field indicates a set of the cell DTX/DRX indication information in the set of candidate values. In some embodiments, the number of the set of DTX/DRX indication information in the set of candidate values is not larger than 2. In some embodiments, a ‘0’ bit indication represents the first set of DTX/DRX indication information. In some embodiments, a ‘1’ bit indication represents the second set of DTX/DRX indication information.

In some embodiments, the wake-up indication field can be reinterpreted as the cell DTX/DRX indication information. For example, a ‘0’ bit indication represents at least one of the disabling/deactivating of the cell DTX/DRX indication information or first value of the cell DTX/DRX indication information or not starting the cell DTX/DRX on-duration timer or disabling the cell DTX/DRX on-duration/periodicity/functionality. For example, a ‘1’ bit indication represents enabling/activating the cell DTX/DRX indication information or second value of the cell DTX/DRX indication information or starting the cell DTX/DRX on-duration timer or enabling the cell DTX/DRX on-duration/periodicity/functionality.

In some embodiments, when the cell DTX/DRX indication information is triggered by L1 signaling, the cell DTX/DRX indication information is indicated by DCI format 2-7.

In some embodiments, the start bit location of the cell DTX/DRX indication information is immediately after the TRS availability indication field and/or Paging indication field.

In some embodiments, the field of the cell DTX/DRX indication information indicates at least one of the cell DTX/DRX indication information.

In some embodiments, the size of the field of the cell DTX/DRX indication information is equal to the number of the cell DTX/DRX indication information, or rounding up the value of log 2(I), or the number of cells configured for the UE. Here, I represents the number of candidate values of the cell DTX/DRX indication information. In some embodiments, at least one of the cells are configured with the cell DTX/DRX.

In some embodiments, the field of the cell DTX/DRX indication information is a bitmap with a size equal to the number of UEs in a group or the number of groups of UEs or a number of cell groups. For example, each bit of the field indicates a set of the cell DTX/DRX indication information in the set of candidate values. In some embodiments, the number of the set of DTX/DRX indication information in the set of candidate values is not larger than 2. In some embodiments, a ‘0’ bit indication represents the first set of DTX/DRX indication information. In some embodiments, a ‘1’ bit indication represents the second set of DTX/DRX indication information.

In some embodiments, the Paging indication field can be reinterpreted as the indication of start offset or offset included in the cell DTX/DRX indication information to determine the start offset of the UE DRX on-duration and/or UE DRX cycle and/or cell DTX/DRX on-duration and/or cell DTX/DRX cycle.

In some embodiments, the TRS availability indication field can be reinterpreted to indicate the cell DTX/DRX indication information. For example, a ‘0’ bit indication represents at least one of the disabling/deactivating of the cell DTX/DRX indication information or first value of the cell DTX/DRX indication information or not starting the cell DTX/DRX on-duration timer or disabling the cell DTX/DRX on-duration/periodicity/functionality. For example, a ‘1’ bit indication represents enabling/activating the cell DTX/DRX indication information or second value of the cell DTX/DRX indication information or starting the cell DTX/DRX on-duration timer or enabling the cell DTX/DRX on-duration/periodicity/functionality.

In some embodiments, the DCI format 2-7 can be used to indicate the availability of the start time of cell DTX/DRX on duration during a cell DTX/DRX cycle, or the availability of one or more occasions for cell DTX/DRX on duration during a cell DTX/DRX cycle.

In some embodiments, the number of bits of the cell DTX/DRX indication field is equal to the number of the start time/occasions of cell DTX/DRX on duration/UE DRX on duration during a time duration. Wherein the time duration is a cell DTX/DRX cycle or a cell DTX/DRX on duration.

In some embodiments, when the cell DTX/DRX indication information is triggered by L1 signaling, a PDCCH monitoring adaptation field with a DCI format 0_1 and a DCI format 0_2 that schedule PUSCH transmission, and a DCI format 1_1 and a DCI format 1_2 that schedule PDSCH receptions, can indicate the cell DTX/DRX indication information when some conditions are satisfied. In some embodiments, the condition enables a PDCCH monitoring adaptation field to indicate cell DTX/DRX indication information including at least one of the following:

Condition-1: A UE can be provided a set of durations by PDCCHSkippingDurationList for PDCCH monitoring on an active DL BWP of a serving cell.

Condition-2: A UE can be provided group indexes for a Type3-PDCCH CSS set or USS set by searchSpaceGroupIdList-r17 for PDCCH monitoring on an active DL BWP of a serving cell.

Condition-3: Condition-1 and/or the UE is not provided searchSpaceGroupIdList-r17 on the active DL BWP of the serving cell.

Condition-4: There is not a third value in the set of durations for skipping PDCCH monitoring.

Condition-5: Condition-2 and/or the UE is not provided PDCCHSkippingDurationList for the active DL BWP of the serving cell.

Condition-6: Condition-1 and/or Condition-2.

Condition-7: The set of durations includes one value and for PDCCH monitoring by the UE according to Type3-PDCCH CSS sets or USS sets on the active DL BWP of the serving cell.

Condition-8: The PDCCH monitoring adaptation field has 2 bits.

Condition-9: The ‘11’ value of a PDCCH monitoring adaptation field is used to indicate cell DTX/DRX indication information.

Condition-10: The cell DTX/DRX is supported by the UE or is configured for the UE by higher layer signaling.

In some embodiments, when the cell DTX/DRX indication information is triggered by L1 signaling, the reserved bits field of DCI format 1-0 with CRC scrambled by C-RNTI or CS-RNTI or MCS-C-RNTI or P-RNTI or SI-RNTI or RA-RNTI or MsgB-RNTI or TC-RNTI is used to indicate the cell DTX/DRX indication information. For example, the reserved bits field indicates activating or deactivating cell DTX/DRX pattern/on duration/functionality.

In some embodiments, the cell DTX/DRX indication information includes at least one of the cell DTX/DRX indication information as described above.

In some embodiments, if the UE detects DCI format 1-0 with CRC scrambled by C-RNTI or CS-RNTI or TC-RNTI or RA-RNTI or MsgB-RNTI, the cell DTX/DRX indication information is applied for a UE.

In some embodiments, if the UE detects DCI format 1-0 with CRC scrambled by P-RNTI or SI-RNTI or TC-RNTI or RA-RNTI or MsgB-RNTI, the indication information related to the cell DTX/DRX is applied for a cell.

In some embodiments, the SCell dormancy indication field in DCI format 0-1 or DCI format 1-1 can be used to indicate the DTX/DRX indication information.

In some embodiments, some certain fields of DCI format 1-1 are used to indicate the cell DTX/DRX indication information in response to at least one of the following conditions is met.

Condition-1: the CRC of DCI format 1_1 is scrambled by a C-RNTI or a MCS-C-RNTI,

Condition-2: a one-shot HARQ-ACK request field is not present or has a ‘O’ value,

Condition-3: the UE detects a DCI format 1_1 on the primary cell that does not include a carrier indicator field, or detects a DCI format 1_1 on the primary cell that includes a carrier indicator field with value equal to 0,

Condition-4: resourceAllocation=resourceAllocationType0 and all bits of the frequency domain resource assignment field in DCI format 1_1 are equal to 0,

Condition-5: resourceAllocation=resourceAllocationTypel and all bits of the frequency domain resource assignment field in DCI format 1_1 are equal to 1,

Condition-6: resourceAllocation=dynamicSwitch and all bits of the frequency domain resource assignment field in DCI format 1_1 are equal to 0 or 1,

Condition-7: the UE considers the DCI format 1_1 as indicating SCell dormancy, not scheduling a PDSCH reception,

In some embodiments, said certain fields of DCI format 1-1 include at least one of the followings:
modulation and coding scheme for transport block 1,
new data indicator for transport block 1,
redundancy version for transport block 1,
HARQ process number,
antenna port(s), or
DMRS sequence initialization.

In some embodiments, when the cell DTX/DRX indication information is triggered by L1 signaling, a DCI can indicate the cell DTX/DRX indication information by one or more fields. For example, the DCI includes at least one of DCI format 0-0 and/or DCI format 0-1 and/or DCI format 0-2 and/or DCI format 1-0 and/or DCI format 1-1 and/or DCI format 1-2 and/or DCI format 3-0 and/or DCI format 2-0 and/or DCI format 2-1 and/or DCI format 2-2 and/or DCI format 2-3 and/or DCI format 2-4 and/or DCI format 2-5 and/or DCI format 2-6 and/or DCI format 2-7.

In some embodiments, when the cell DTX/DRX indication information is triggered by L1 signaling, a new DCI format is used to indicate the cell DTX/DRX indication information. In some embodiments, the new DCI format is new to any of DCI formats in NR Rel-17. In some embodiments, the CRC of the new DCI format is scrambled by a new RNTI that is new to any of DCI formats in NR Rel-17.

In some embodiments, two-level L1 signaling including a first DCI and a second DCI is used to indicate cell DTX/DRX indication information. Wherein the first DCI indicates a first kind of cell DTX/DRX indication information. Wherein the second DCI indicates a second kind of cell DTX/DRX indication information. In some embodiments, the first kind of cell DTX/DRX indication information includes at least one of the above cell DTX/DRX indication information and the second kind of cell DTX/DRX indication information indicates at least one of an offset to modify the value of the UE DRX start offset or slot offset or the UE DRX indication information or the cell DTX/DRX activation/deactivation, or the cell DTX/DRX indication information. In some embodiments, UE monitors PDCCH carrying the first DCI during a first time window and monitors PDCCH carrying the second DCI during a second time window. Wherein the first time window is located before or after the start of the cell DTX/DRX on duration and the second time window is located before or at or after the end of the cell DTX/DRX on duration. In some embodiments, the first time window is during cell DTX/DRX on duration or cell DTX/DRX active time, the second time window is during cell DTX/DRX off duration or cell DTX/DRX non active time.

For example, the UE detects the first DCI during cell DTX on duration wherein the first DCI indicates activating/deactivating a cell DTX pattern or starting/stopping a cell DTX on duration. For example, the UE detects the second DCI after the cell DTX on duration or during the cell DTX off duration wherein the second DCI indicates to start the UE DRX on duration timer based on an offset. Wherein the offset used to determine the new start offset of the UE DRX on duration timer.

For example, the UE detects the first DCI during cell DTX on duration wherein the first DCI indicates deactivating a cell DTX pattern or stopping a cell DTX on duration. For example, the UE detects the second DCI after the cell DTX on duration or during the cell DTX off duration wherein the second DCI indicates activating/deactivating cell DTX pattern or starting a cell DTX on duration.

In some embodiments, when the cell DTX/DRX indication information is triggered by L2 signaling, a MAC CE can indicate the cell DTX/DRX indication information.

The bit field indicating the cell DTX/DRX indication information is determined in accordance to at least one of the following methods:

Method 1: one or more bits in the bit field used to indicate cell DTX and/or cell DRX indication information.

I. The bit field can be used to indicate cell DTX when the UE is provided by parameters related to cell DTX configured by higher layer parameters and indicate cell DRX the UE is provided by parameters related to cell DRX configured by higher layer parameters. In some embodiments, the bit field does not indicate cell DTX and cell DRX together. Field in DCI format 0-1/0-2 indicates cell DRX. Field in DCI format 1-1/1-2 indicates cell DTX.

II. A first bit field is used to indicate cell DTX indication information and a second bit field is used to indicate cell DRX indication information. In some embodiments, a first bit field is not present if the UE is not provided by parameters related to cell DTX configured by higher layer parameters. In some embodiments, a second bit field is not present if the UE is not provided by parameters related to cell DRX configured by higher layer parameters.

III. A first part of bit(s) in the bit field is used to indicate cell DTX indication information and a second part of bit(s) in the bit field is used to indicate cell DRX indication information. In some embodiments, the first part of bit(s) and a second part of bit(s) are not overlapped in the bit field.

Method 2: one or more triggering states of the bit field are used to indicate cell DTX/DRX indication information.

I. A number of bits (denoted as N) in the bit field is used to indicate cell DTX/DRX indication information. In some embodiments, the number of triggering states (denoted as M) that is used to indicate cell DTX/DRX indication information is not larger than 2N.

II. In some embodiments, a first triggering state is used to indicate a state of at least one of the cell DTX indication information and a second triggering state is used to indicate a state of at least one of the cell DRX indication information. For example, N=2 and the triggering state of ‘00’ is used to indicate cell DTX deactivation, ‘01’ is used to indicate cell DTX activation, ‘10’ is used to indicate cell DRX deactivation, and ‘11’ is used to indicate cell DRX activation.

III. In some embodiments, a triggering state is used to indicate the state of at least one of the cell DTX indication information and cell DRX indication information. For example, N=2 and the triggering state of ‘00’ is used to indicate cell DTX and cell DRX deactivation. For example, the triggering state of ‘01’ is used to indicate cell DTX and cell DRX activation. For example, the triggering states of ‘10’ and ‘11’ are used to indicate cell DTX or cell DRX activation and/or deactivation.

IV. In some embodiments, at least one of the triggering states can reinterpreted the cell DTX/DRX indication information corresponding to other triggering states or enable at least one of the remaining triggering states indicating the cell DTX/DRX indication information. In some embodiments, a first triggering state indicates a first cell DTX/DRX indication information and enables one or more remaining triggering states to indicate a second cell DTX/DRX indication information. In some embodiments, a third triggering state indicates a third cell DTX/DRX indication information and enables one or more remaining triggering states to indicate a fourth cell DTX/DRX indication information. Wherein the second and the fourth cell DTX/DRX indication information indicate different values of one of cell DTX/DRX indication information. Wherein the second and the fourth cell DTX/DRX indication information indicate different kinds of cell DTX/DRX indication information. For example, N=2 and 4 triggering states are used for cell DTX/DRX indication information. For example, after the DCI indicates cell DTX and cell DRX activation, the triggering states of ‘00’ and ‘01’ are used to indicate cell DTX deactivation and cell DRX deactivation respectively. For example, after the DCI indicates cell DTX and cell DRX deactivation, the triggering states of ‘10’ and ‘11’ are used to indicate cell DTX activation and cell DRX activation respectively.

Method 3: a bitmap of the bit field is used to indicate cell DTX/DRX indication information.

I. Each bit corresponds to one of the cell DTX/DRX indication information.

II. Each bit corresponds to one kind of a cell DTX/DRX indication information.

III. Each bit corresponds to one state of a cell DTX/DRX indication information.

IV. A first part of bits is used to indicate cell DTX indication information, and a second part of bits is used to indicate cell DRX indication information. For example, ‘1000’ indicates cell DTX activation, ‘0001’ indicates cell DRX activation. For example, ‘1000’ indicates cell DTX activation and cell DRX deactivation, ‘0001’ indicates cell DRX activation and cell DTX deactivation. For example, ‘1001’ indicates cell DTX activation and cell DRX activation.

V. Each bit corresponds to one of the cell DTX/DRX indication information in a cell.

VI. A first part of bits is used to indicate cell DTX indication information in one or more cells, and a second part of bits is used to indicate cell DRX indication information in one or more cells. In some embodiments, each two bits are used to indicate cell DTX and cell DRX indication information in one cell. For example, ‘1000’ indicates cell DTX activation and cell DRX deactivation in a first cell, and cell DTX and cell DRX deactivation in a second cell; ‘0001’ indicates cell DTX/DRX deactivation in a first cell and cell DTX deactivation and cell DRX activation in a second cell.

In some embodiments, a bit field is used to indicates cell DTX and cell DRX indication information for FDD.

In some embodiments, two parts of bits of a bitmap in a bit field are used to indicate cell DTX and cell DRX indication information for TDD respectively.

In accordance with an embodiment, for RRC connected mode UE, in order to trade off reliability and energy saving performance, the signaling mechanism for the cell DTX/DRX may include at least one of the following:
at least one group of cells DTX/DRX is configured for a group of UEs;
at least one the UE DRX indication information is configured for one or more UEs;
for CA scenario, if a UE detects the cell DTX/DRX indication in PCell, the UE assumes that the same cell DTX/DRX is used for SCells supported by the UE.

### Application of the Cell DTX/DRX Indication Information

In accordance with an embodiment, the UE applies the cell DTX/DRX indication information with an application delay after the reception of the PDCCH (e.g., containing the cell DTX/DRX indication information).

In some embodiments, the application delay is at least one of the following:
The duration after the PDCCH reception to the beginning of a next cell DTX/DRX cycle or the cell DTX/DRX on-duration.
The duration configured by higher layer parameter.
The duration is in units of symbols/slots/subframes/frames/the cell DTX cycles/the cell DRX cycles.
The duration is determined based on SCS configuration for a cell, the cell DTX/DRX cycle, start offset for the cell DTX/DRX and/or the UE DRX, offset, the cell DTX/DRX on-duration, the UE DRX cycle, the UE DRX on-duration, HARQ-ACK information, the value of minimum applicable scheduling offset K0/K1/K2, and/or the number of data retransmission.
The value of the duration is determined by the product of SCS and/or the value configured by higher layer parameter.
The candidate value of application delay is configured by higher layer parameter.
The duration is 3 milliseconds after a report of HARQ-ACK information. In some embodiments, the HARQ-ACK information carries the HARQ-ACK information of MAC CE that indicates the cell DTX/DRX indication information.

In some embodiments, if a UE is provided by the cell DTX/DRX configured by higher layer parameter or receives the cell DTX/DRX activation indication by a MAC CE, the UE assumes that the cell DTX/DRX activation indication is valid after 3 milliseconds from the report of HARQ-ACK information for the MAC CE.

In some embodiments, if a UE is provided by the cell DTX/DRX configured by higher layer parameter or receives the cell DTX/DRX deactivation indication by L1 signaling, the UE deactivates the cell DTX/DRX and performs normal DL reception/UL transmission after an application delay. The delay is related to the SCS configuration for a group of cells, or the BWP switching delay triggered by timer or a DCI, or the application delay for minimum applicable scheduling offset indication, or the application delay for PDCCH monitoring adaptation. In some embodiments, normal DL reception/UL transmission include PDCCH monitoring, PDSCH reception, or PUCCH/PUSCH transmission, or common signal/channel reception.

In some embodiments, if a UE receives the cell DTX/DRX activation information indicated by L1 signaling, the UE starts/applies the cell DTX/DRX operation from a slot after an application delay, or after PDSCH reception, or after PDSCH reception successfully, or after PUCCH/PUSCH transmission successfully, or at the start of next cell DTX/DRX cycle, or at the start of the search time for DCI format 2-6. The delay is related to the SCS configuration for a group of cells, or the BWP switching delay triggered by timer or a DCI, or the application delay for minimum applicable scheduling offset indication, or the application delay for PDCCH monitoring adaptation.

In some embodiments, the UE does not monitor PDCCH during an application delay for applying the cell DTX/DRX indication information.

In some embodiments, the value of application delay is related to subcarrier spacing (SCS) u. The value of application delay is in units of symbols or slots or subframes or frames and is determined by the product of SCS and/or the value configured by higher layer parameter. The candidate values of application delay are configured by higher layer parameter. The minimum value of application delay is included in the candidate values of application delay.

For example, in the following Table 1, there is provided an example of the minimum value of the application delay in units of symbols. In Table 1, the minimum value of application delay 1 is used for BS or UE requiring larger delay value. Further, the minimum value of application delay 2 is used for BS or UE supporting faster the cell DTX/DRX operation switching capability.

TABLE 1
an example of the minimum value of the
application delay in units of symbols

| | Minimum value | Minimum value |
|---|---|---|
| SCS | of application | of application |
| configuration (μ) | delay 1 | delay 2 |
| 0 | 25 | 10 |
| 1 | 25 | 12 |
| 2 | 25 | 22 |
| 3 | 40 | — |
| 5 | 160 | — |
| 6 | 320 | |

In some embodiments, the UE applies the indication related to the cell DTX/DRX operation at the beginning of a first symbol/slot/subframe/frame/the cell DTX cycle/the cell DTX on-duration/the cell DRX cycle/the cell DRX on-duration that is at least an application delay after the PDCCH reception.

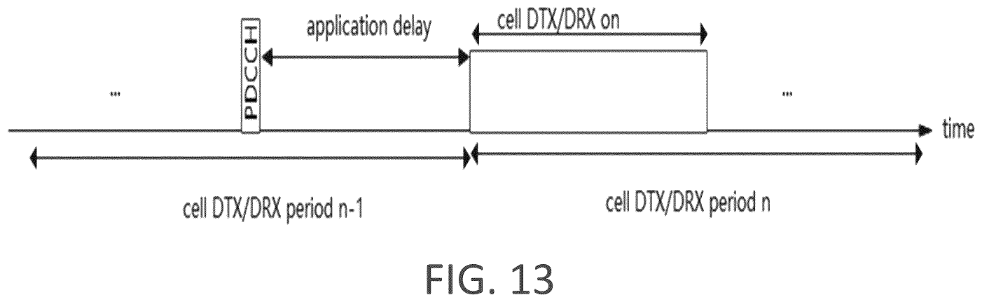

FIG. 13 shows an example of a UE that applies indication of a cell DTX/DRX activation at the beginning of the next cell DRX/DTX cycle in accordance with an embodiment of the present disclosure.

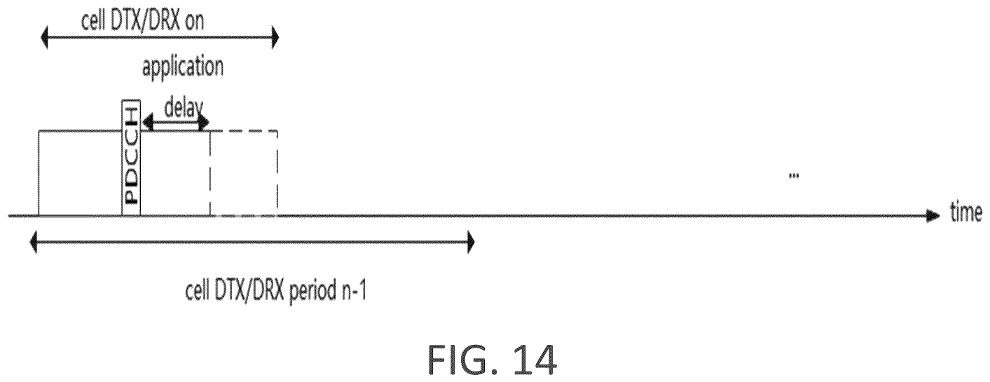

FIG. 14 shows an example of a UE that applies indication of a cell DTX/DRX deactivation at the beginning of a first symbol/slot that is at least an application delay after the PDCCH reception in accordance with an embodiment of the present disclosure.

In some embodiments, the UE applies the indication related to the cell DTX/DRX operation for the current the cell DTX/DRX cycle.

In some embodiments, the UE applies the indication related to the cell DTX/DRX operation for the next subsequent n the cell DTX/DRX cycle. For example, n may be an integer that is not smaller than 0.

In some embodiments, the UE applies the indication related to the cell DTX/DRX operation until the PDCCH reception carrying the updated/new indication related to the cell DTX/DRX operation.

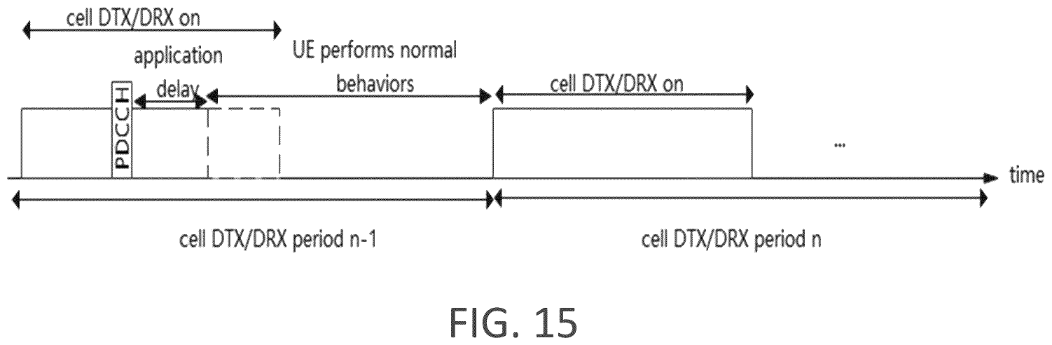

FIG. 15 shows an example of a UE that applies indication of the cell DTX/DRX deactivation for the current the cell DTX/DRX cycle in accordance with an embodiment of the present disclosure. For example, the normal behavior represents that the UE does not perform the cell DTX/DRX operation or that the UE performs the UE DRX operation when the UE DRX is configured.

### Detection of DCI Indicating the Cell DTX/DRX Indication Information

In accordance with an embodiment, the UE detects the PDCCH carrying indication related to the cell DTX/DRX during a time window.

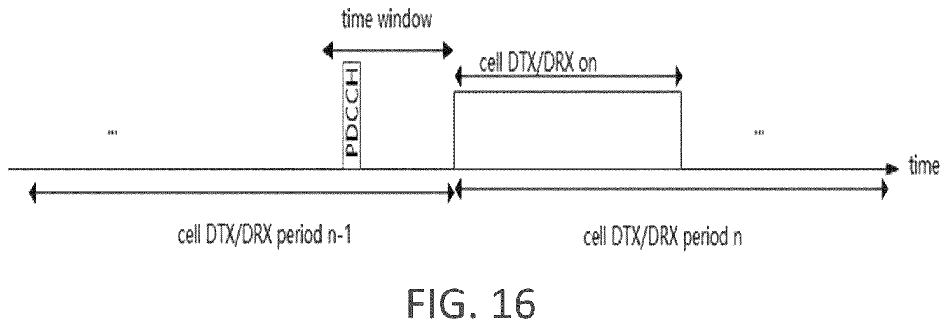

FIG. 16 shows an example of a UE that applies indication of the cell DTX/DRX activation carried by the DCI detected during the time window in accordance with an embodiment of the present disclosure.

In some embodiments, the UE detects a first DCI indicating a first indication information during a first time window, and/or detects a second DCI indicating a second indication information during a second time window.

In some embodiments, the first indication information includes the cell DTX indication information. In some embodiments, the second indication information includes the cell DRX indication information.

In some embodiments, the first indication information includes the cell DTX or the cell DRX indication information. In some embodiments, the second indication information includes indication information associated with the UE DRX.

In some embodiments, the parameter used to determine the time window includes at least one of the following:
start offset, which is used to determine the start of time window;
end offset, which is used to determine the end of time window;
duration of time window, which is used to determine the length of time window;
search space set configuration, which is used to determine the PDCCH monitoring occasions for the detection of DCI carrying the cell DTX/DRX indication information.

In some embodiments, if the UE detects a first DCI indicating a first indication information, and/or detects a second DCI indicating a second indication information, the UE may perform a next action (some examples are provided below).

In some embodiments, the first DCI carries indication information for a group of UE or one UE, and/or the second DCI carries indication information for a group of UE or one UE.

In some embodiments, the RNTI scrambling CRC of the first DCI is the same as that of the second DCI. In some embodiments, the RNTI scrambling CRC of the first DCI is different from that of the second DCI.

In some embodiments, the first indication information includes the cell DTX/DRX indication information. In some embodiments, the second indication information includes the cell DTX/DRX indication information, and/or the UE DRX indication information, and/or wake-up/not wake-up indication, and/or SCell dormancy/non-dormancy behavior indication, and/or minimum applicable scheduling offset indicator.

In some embodiments, the UE detects a first DCI indicating a first indication information during a first time duration, and/or detects a second DCI indicating a second indication information during a second time duration.

In some embodiments, a first indication information applied for a first time duration, and/or a second indication information applied for a second time duration.

In some embodiments, the first time duration and/or the second time duration are an occasion or time duration. In some embodiments, the occasion includes at least one of the PDCCH monitoring occasion. In some embodiments, the PDCCH monitoring occasion is used for the detection of DCI carrying the cell DTX/DRX indication information.

In some embodiments, the first time duration and/or the second time duration are used to monitor PDCCH carrying a second DCI.

In some embodiments, the next action is at least one of the following:
1-Performing the cell DTX/DRX operation according to the first indication information.
2-Performing the cell DTX/DRX operation according to the second indication information.
3-Performing the UE DRX operation according to the second indication information.
4-Ignoring the first indication information.
5-Ignoring the second indication information.
6-Ignoring the indication information associated with the cell DTX/DRX indication information.
7-Ignoring the indication information associated with the UE DRX operation.

In some embodiments, the UE performs the next action when a certain event is met. The certain event may include at least one of the following:
1—The first DCI and/or the second DCI is at least one of DCI format 0-1, DCI format 1-1, DCI format 0-2, DCI format 1-2, DCI format 2-6 and/or a new DCI format.
2—The first DCI and/or the second DCI indicates the cell DTX/DRX indication information and/or indication information associated with the UE DRX operation.
3—The interval of time of detection of the first DCI and the second DCI is not larger than an application delay.
4—The first time duration overlaps the second time duration.
5—The detection of the first DCI and/or the second DCI is during the first time duration overlapping with the second time duration.
6—The time interval between the first PDCCH occasion for detection of the first DCI and the second PDCCH occasion for detection the second DCI is smaller than or equal to the application delay.
7—The value of the first indication information is different from that of the second indication information. For example, the first indication information is used to disable the timer duration of the UE DRX active time, and/or the second indication information is used to enable the timer duration of the UE DRX active time. For example, the second indication information is used to activate the cell DTX/DRX operation, and/or the second indication information is used to deactivate the cell DTX/DRX operation.

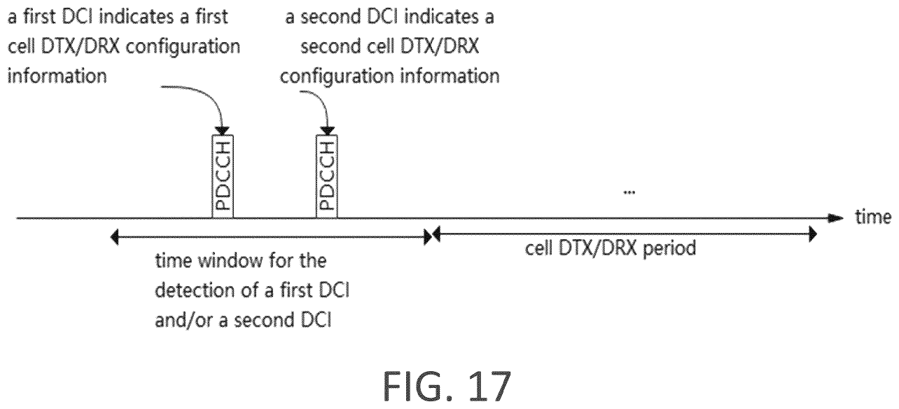

FIG. 17 shows an example where the UE detects a first DCI indicating a first cell DTX/DRX indication information and a second DCI indicating a second cell DTX/DRX indication information during a time duration for the detection of both a first DCI and the second DCI in accordance with an embodiment of the present disclosure. Here, the UE can perform the cell DTX/DRX operation according to the first indication information or the second indication information.

In some embodiments, the indication of the cell DTX/DRX configuration has higher priority than the indication associated with the UE CDRX configuration.

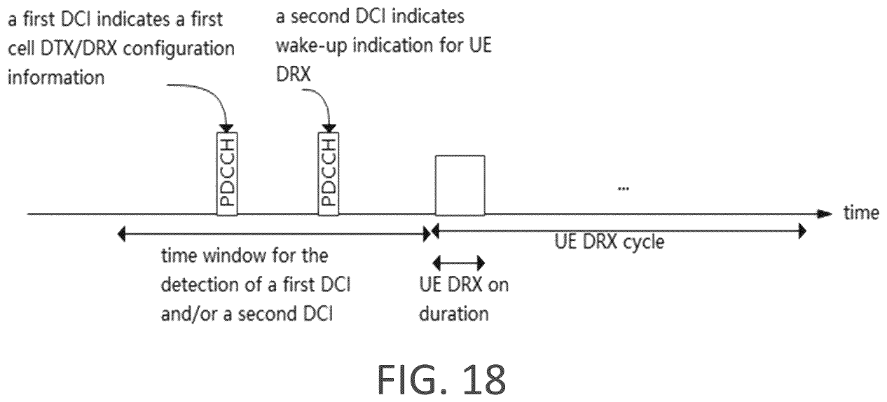

FIG. 18 shows an example where the UE detects a first DCI indicating a first cell DTX/DRX indication information that is used to deactivate or disable the timer duration of the UE DRX active time, and the second DCI indicating a second indication information of wake-up indication for the UE DRX in accordance with an embodiment of the present disclosure. Here, the UE can perform the UE DRX operation according to the second indication information of wake-up indication and/or ignore the first cell DTX/DRX indication information.

In some embodiments, if the UE detects a first DCI indicating a first indication information, and/or detects a second DCI indicating a second indication information during a time window, then:
i. the UE does not expect that the first indication information is different from the second indication information; and/or
ii. the first indication information and a second indication information should be consistent.

A wireless communication method is also provided according to an embodiment of the present disclosure. In an embodiment, the wireless communication method may be performed by using a wireless communication terminal (e.g., a UE). In an embodiment, the wireless communication terminal may be implemented by using the wireless communication terminal 40 described above, but is not limited thereto.

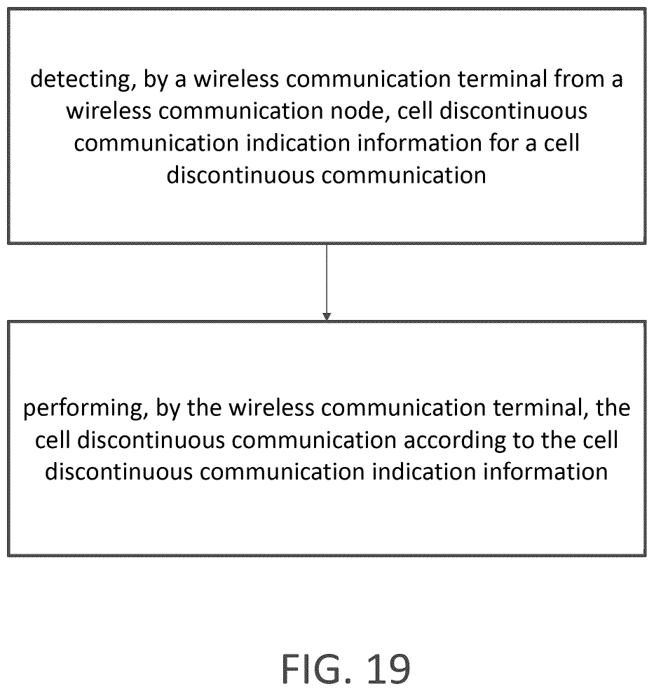

Referring to FIG. 19, in an embodiment, the wireless communication method includes: detecting, by a wireless communication terminal from a wireless communication node, cell discontinuous communication indication information for a cell discontinuous communication; and performing, by the wireless communication terminal, the cell discontinuous communication according to the cell discontinuous communication indication information.

In some embodiments, the cell discontinuous communication indication information may be the cell DTX/DRX indication information described above.

In some embodiments, the cell discontinuous communication may be the cell DTX/DRX described above or the operations of the UE and/or gNB performs for the cell DTX/DRX described above.

Details in this regard can be ascertained with reference to the paragraphs above, and will not be repeated herein.

Another wireless communication method is also provided according to an embodiment of the present disclosure. In an embodiment, the wireless communication method may be performed by using a wireless communication node (e.g., a gNB or a BS). In an embodiment, the wireless communication node may be implemented by using the wireless communication node 50 described above, but is not limited thereto.

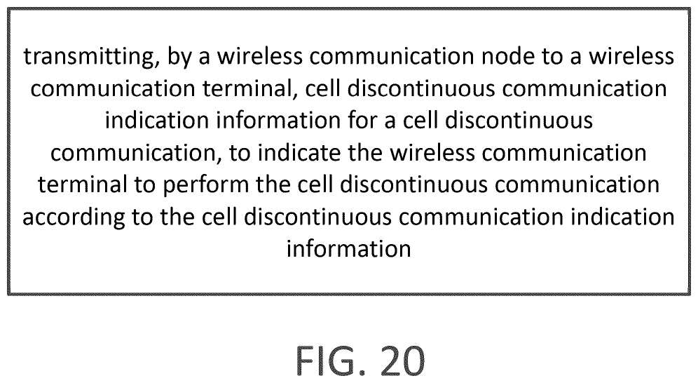

Referring to FIG. 20, in an embodiment, the wireless communication method includes transmitting, by a wireless communication node to a wireless communication terminal, cell discontinuous communication indication information for a cell discontinuous communication, to indicate the wireless communication terminal to perform the cell discontinuous communication according to the cell discontinuous communication indication information.

Details in this regard can be ascertained with reference to the paragraphs above, and will not be repeated herein.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that, as used herein, including in the claims, “or” as used in a list of items (e.g., a list of items prefaced by a phrase such as “at least one of” or “one or more of”) indicates an inclusive list such that, for example, a list of at least one of A, B or C means A or B or C or AB or AC or BC or ABC (i.e., A and B and C). Also, as used herein, the phrase “based on” may not be construed as a reference to a closed set of conditions. For example, an example step that is described as “based on condition A” may be based on both a condition A and a condition B without departing from the scope of the present disclosure. In other words, as used herein, the phrase “based on” may be construed in the same manner as the phrase “based at least in part on.”

It is also understood that, as used herein, including in the claims, A is “associated with” or “related to” B may indicate that A includes B or B includes A or A includes at least one of B or B includes at least one of A.

It is also understood that, the base station (BS) may mean that a communication node, or BTS (Base Transceiver Station) in 2G, or NodeB in 3G, or eNB (E-UTRAN NodeB/enhanced NodeB) in 4G, or gNB (gNodeB) in 5G, or a base station of LTE (Long term evolution) or NR (New Radio access technology), or a base station of further generation communication system, or a cell with a normal state or activated state or deactivated state or dormant state, or a cell providing basic coverage, or a cell boosting capacity, or a small cell, or a primary cell, or a secondary cell.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

What is claimed is:

1. A wireless communication method comprising:
detecting, by a wireless communication terminal from a wireless communication node, cell discontinuous communication indication information for a cell discontinuous communication; and
performing, by the wireless communication terminal, the cell discontinuous communication according to the cell discontinuous communication indication information.

2. The wireless communication method of claim 1, wherein the cell discontinuous communication comprises at least one of a discontinuous transmission (DTX) or a discontinuous reception (DRX).

3. The wireless communication method of claim 1, wherein, a cell DTX active time or a cell DRX active time for the serving cell includes at least a duration in case a timer is running during a cell DTX cycle or a cell DRX cycle and wherein the timer is configured with the cell DTX or the cell DRX in case a cell DTX or a cell DRX is configured in a serving cell of a UE.

4. The wireless communication method of claim 1, wherein a cell DTX indication information or a cell DRX indication information is indicated by L1 signaling.

5. The wireless communication method of claim 4, wherein a different downlink control information (DCI) format is used to indicate the cell DTX indication information or the cell DRX indication information.

6. The wireless communication method of claim 5, wherein the different DCI format is different to any of DCI formats in NR Rel-17, or wherein a cyclic redundancy check (CRC) of the different DCI format is scrambled by a different radio network temporary identifier (RNTI) that is different to any of DCI formats in NR Rel-17.

7. The wireless communication method of claim 1, wherein a first bit field is used to indicate a cell DTX indication information and wherein a second bit field is used to indicate a cell DRX indication information, or wherein the first bit field is not present in case a UE is not provided by parameters related to cell DTX configured by higher layer parameters and/or wherein the second bit field is not present in case a UE is not provided by parameters related to cell DRX configured by higher layer parameters.

8. The wireless communication method of claim 1, wherein a triggering state is used to indicate a state of at least one of a cell DTX indication information and a cell DRX indication information.

9. The wireless communication method of claim 1, wherein a UE applies cell DTX indication information or cell DRX indication information with an application delay after the reception of a Physical Downlink Control Channel (PDCCH).

10. A wireless communication method comprising:
transmitting, by a wireless communication node to a wireless communication terminal, cell discontinuous communication indication information for a cell discontinuous communication, to indicate the wireless communication terminal to perform the cell discontinuous communication according to the cell discontinuous communication indication information.

11. The wireless communication method of claim 10, wherein the cell discontinuous communication comprises at least one of a discontinuous transmission (DTX) or a discontinuous reception (DRX).

12. The wireless communication method of claim 10, wherein, a cell DTX active time or a cell DRX active time for the serving cell includes at least a duration in case a timer is running during a cell DTX cycle or a cell DRX cycle and wherein the timer is configured with the cell DTX or the cell DRX in case a cell DTX or a cell DRX is configured in a serving cell of a UE.

13. The wireless communication method of claim 10, wherein a cell DTX indication information or a cell DRX indication information is indicated by L1 signaling.

14. The wireless communication method of claim 13, wherein a different downlink control information (DCI) format is used to indicate the cell DTX indication information or the cell DRX indication information.

15. The wireless communication method of claim 14, wherein the different DCI format is different to any of DCI formats in NR Rel-17, or wherein a cyclic redundancy check (CRC) of the different DCI format is scrambled by a different radio network temporary identifier (RNTI) that is different to any of DCI formats in NR Rel-17.

16. The wireless communication method of claim 10, wherein a first bit field is used to indicate a cell DTX indication information and wherein a second bit field is used to indicate a cell DRX indication information, and
wherein the first bit field is not present in case a UE is not provided by parameters related to cell DTX configured by higher layer parameters and/or wherein the second bit field is not present in case a UE is not provided by parameters related to cell DRX configured by higher layer parameters.

17. The wireless communication method of claim 10, wherein a triggering state is used to indicate a state of at least one of a cell DTX indication information and a cell DRX indication information.

18. The wireless communication method of claim 10, wherein a UE applies cell DTX indication information or cell DRX indication information with an application delay after the reception of a Physical Downlink Control Channel (PDCCH).

19. A wireless communication terminal comprising:
a communication unit; and
at least one processor configured to: detect, via the communication unit from a wireless communication node, cell discontinuous communication indication information for a cell discontinuous communication; and perform the cell discontinuous communication according to the cell discontinuous communication indication information.

20. A wireless communication node comprising:
a communication unit; and
at least one processor configured to perform the method of claim 10.
